(19) United States
(12) Patent Application Publication
(10) Pub. No.: US 2015/0088744 A1
(43) Pub. Date: Mar. 26, 2015

(54) Transaction Authentication

(71) Applicant: eIngot LLC, Great Falls, VA (US)

(72) Inventor: William J. Raduchel, Great Falls, VA (US)

(73) Assignee: eIngot LLC, Great Falls, VA (US)

(21) Appl. No.: 14/491,500

(22) Filed: Sep. 19, 2014

Related U.S. Application Data
(60) Provisional application No. 61/880,793, filed on Sep. 20, 2013.

(51) Int. Cl. G06Q 20/40; G06Q 50/00

(52) U.S. Cl. CPC G06Q 20/40; G06Q 50/01
USPC 705/44

(57) ABSTRACT

Information is received that includes a request to authenticate a transaction. Based on the received information, a location associated with the transaction and a user associated with the transaction are identified. Location data is accessed that identifies one or more locations associated with the user. The location associated with the transaction and the one or more locations associated with the user are compared to determine whether the location associated with the transaction corresponds to a location associated with the user. A response to the request is provided based on determining whether the location associated with the transaction corresponds to the location associated with the user.

### CROSS-REFERENCE TO RELATED APPLICATION

This application claims the benefit of U.S. Provisional Application Ser. No. 61/880,793, filed on Sep. 20, 2013, which is incorporated by reference.

### TECHNICAL FIELD

This disclosure relates to authenticating requests to perform transactions.

### BACKGROUND

Users associated with user accounts can request to perform transactions by providing a credential associated with the user account. For example, a user having a credit or bank account can request to perform a purchase by providing a credit or bank card to a merchant.

### BRIEF DESCRIPTION OF THE DRAWINGS

FIGS. 1 and 2 are illustrations of example systems for performing social network based transaction authentication;

FIGS. 3A and 3B illustrate example user interfaces of a social network that include information used for location determination; and

FIG. 4 is a flowchart of an example process used in performing social network based transaction authentication.

Like reference symbols in the various drawings indicate like elements.

### DETAILED DESCRIPTION

Users associated with user accounts, such as credit accounts, debit accounts, and the like, can perform transactions by providing credentials that identify their user account to a merchant. As used in this specification, performing a transaction can include providing a request to perform a transaction, such as by providing a credential to a merchant that identifies the user and the user's account. For example, a user having a credit account can perform a transaction by providing a credit card to a merchant, where the credit card identifies information about the user and the user's account. The information identifying the user and the user's account can enable authentication of the transaction such that the merchant may then process the transaction, e.g., by processing a purchase of a good or service. To prevent fraudulent transactions, user account issuers, such as credit banks or commercial banks, can require that certain conditions are satisfied before a transaction is authenticated.

In some implementations, an account issuer may condition that a transaction can only be authenticated if the transaction is performed within particular geographic regions, such as geographic regions where the user is likely to perform transactions. For example, a user associated with a credit account may live in a particular region of the United States, and the credit account issuer may condition that transactions may only be authenticated if the transaction is performed within the particular region of the United States.

At times, a user associated with an account may be at a location that is not included in the particular geographic regions where transactions may be authenticated, and the user may attempt to perform a transaction using the account while at that location. For example, a user from the United States having a credit account may be travelling in Italy, and may attempt to perform a transaction while in Italy. Based on a condition associated with the user's credit account specifying that the user can only perform transactions from within particular regions of the United States, the user's transaction may be declined.

To enable such transactions to be properly authenticated, information registered with a social networking platform can be accessed and a current location of the user can be predicted. Social networking platforms, such as Facebook, Twitter, Google+, LinkedIn, MySpace, Pinterest, LiveJournal, Instragram, and others, enable users to provide information about themselves, including places that they have visited or plan to visit, or events that they have attended or plan to attend. In many instances, places and events are associated with geographic locations, and users can provide information to the social network that identifies geographic locations. For instance, users can identify locations they visit by posting messages to a social network that identify the locations, by tagging a geographic location in association with an image, video, or other media, or by performing a “check-in” that indicates a location of the user at a particular time.

Information that identifies locations where the user has visited or plans to visit can be accessed and analyzed to predict locations where a user may be located, or may be located in the future. The predicted location information can be used in determining whether to authenticate transactions performed by the user. For example, the user from the United States can post an image at a social network that identifies a location in Italy and a transaction performed by the user while they are in Italy can be authenticated, based on determining from the image posted at the social network that the user is likely located in Italy at the time the user performs the transaction.

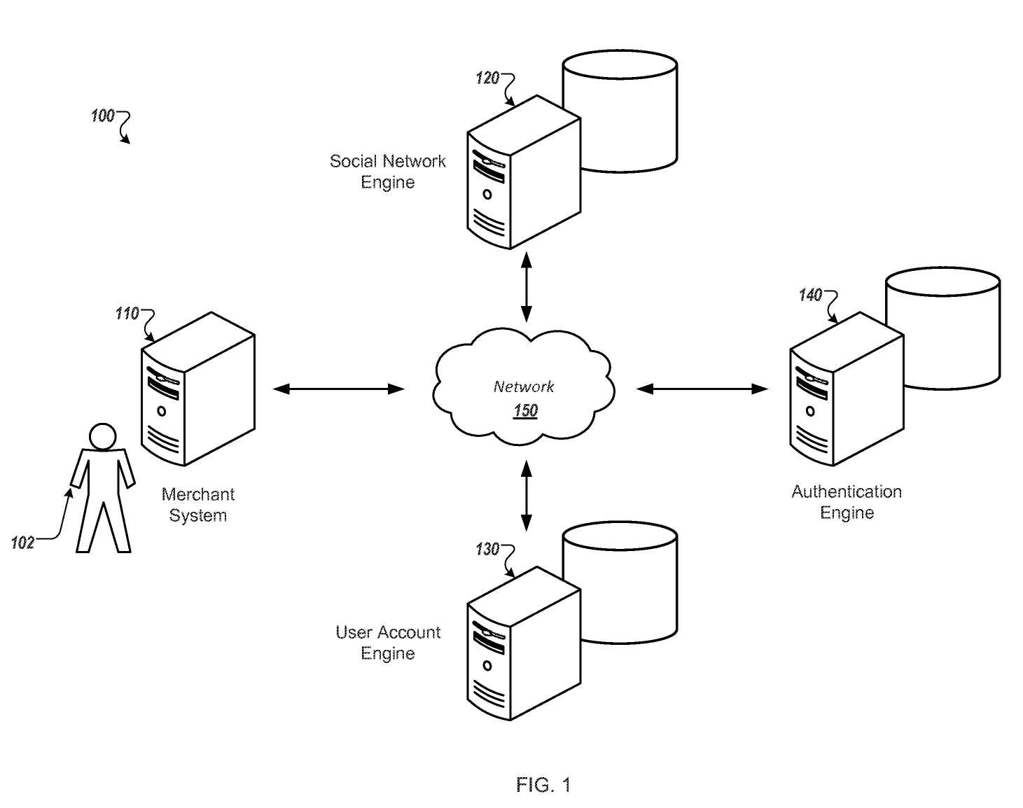

FIG. 1 illustrates an example system 100 for performing social network based transaction authentication. Specifically, the system 100 enables a user of a social networking platform to provide information that includes location data to a social networking platform, where the location data identifies locations that a user has, is, or will be located. The system 100 can utilize the location data to perform social network based transaction authentication.

Briefly, the system 100 includes a merchant system 110, a social network engine 120, a user account engine 130, and an authentication engine 140. The merchant system 110, social network engine 120, user account engine 130, and authentication engine 140 are each able to communicate over the network 150.

The social network engine 120 can receive and store location data provided by a user 102 that identifies locations where the user 102 is, has been, or will be located. The user 102 can register the location data with the social network engine 120 by accessing a social networking platform using a client device, such as a mobile phone, smart phone, personal digital assistant (PDA), music player, e-book reader, tablet computer, laptop computer, desktop computer, wearable computing device, or other device, and providing information that identifies the user 102 and one or more locations. In some instances, the user 102 can register the location data using the client device while the client device is in communication with the social network engine 120 over the network 150.

At a point in time, the user 102 can perform a transaction by providing a credential to the merchant system 110 that identifies a user account associated with the user 102. As described, performing a transaction can include providing a request to perform a transaction or otherwise attempting to have a particular transaction processed. For example, the user 102 can be associated with a user account, e.g., a credit account, debit account, checking account, savings account, account associated with a particular merchant, gift account, PayPal account, or any other account that can be used by the user to perform transactions, and can perform a transaction by providing a merchant with a credential identifying the user account. For example, the user 102 can present a credit card, debit card, check card, gift card, user account information, or other credential used to identify the user's account to the merchant to perform the transaction. As used in this disclosure, a merchant can be any individual, group of individuals, or other entity, e.g., business or group of businesses, that is capable of performing transactions or receiving requests to perform transactions. For instance, a merchant can be an individual person or a group of people that accept transactions in exchange for goods or services, can be a business, e.g., a retailer, service provider, financial institution, or other business or group of businesses, or can be any other entity capable of performing transactions or requests for transactions, e.g., a non-profit organization that accepts donations.

The credential identifying the user account associated with the user 102 can be provided to the merchant system 110, and the merchant system 110 can transmit the information associated with the credential. The merchant system 110 can transmit the information associated with the credential, for example, to the user account engine 130 in order to perform authentication of the transaction. As used in this specification, a merchant system 110 can be any system capable of receiving and transmitting information associated with credentials that identify user accounts, e.g., a card reader device, an application associated with a card reader, an application hosted on a client device, an application accessible over a network, a website or other web-based resource, or any other system capable of receiving information associated with credentials and submitting the information associated with the credentials for transaction authentication. In some implementations, the information associated with the credential is transmitted by the merchant system 110 over the network 150, where the network 150 can be one or more local area networks (LAN), or wide area networks (WAN), such as the Internet. In some implementations, the merchant system 110 is capable of encrypting and/or decrypting the information associated with the credential as necessary to maintain security of the credential and/or to enable secure transaction authentication.

In addition to transmitting information associated with the credential, the merchant system 110 can also identify and transmit information associated with the transaction. For instance, the merchant system 110 can identify information associated with the transaction performed by the user 102, e.g., an amount of money associated with the transaction, a location associated with the transaction, a time associated with the transaction, a merchant associated with the transaction, a credential type provided by the user 102 in association with the transaction, an identification of the subject of the transaction, such as the good or service being purchased by the user 102 in connection with the transaction, and/or other relevant information, and can transmit the identified information along with the information associated with the credential. In some implementations, the information associated with the credential and the information associated with the transaction can be transmitted by the merchant system 110 in a single data packet, or can be transmitted in separate data packets. In some implementations, the information associated with the credential and the information associated with the transaction can be transmitted by the merchant system 110 at the same time, or can be transmitted by the merchant system 110 at different times. In some implementations, the merchant system 110 can transmit the information associated with the credential and the information associated with the transaction to a single recipient, e.g., in a single data packet, or can transmit the information associated with the credential and the information associated with the transaction to multiple, different recipients, e.g., in separate data packets.

The authentication engine 140 can receive the information associated with the credential and the information associated with the transaction, and can use the information associated with the credential and the transaction to authenticate the transaction. For example, the authentication engine 140 can receive the information associated with the credential and the information associated with the transaction from the merchant system 110 over the network 150. Based on receiving the information associated with the credential and the transaction, the authentication engine 140 performs operations to authenticate the transaction. As described, the authentication engine 140 can authenticate the transaction based on performing social network based transaction authentication.

In some implementations, the authentication engine 140 can transmit the information associated with the credential to the user account engine 130. For example, the authentication engine 140 can transmit the information associated with the credential to the user account engine 130 over the network 150. In some instances, the authentication engine 140 can additionally or alternatively transmit the information associated with the transaction to the user account engine 130, for example, by transmitting the information associated with the transaction to the user account engine 130 over the network 150.

The user account engine 130 can receive the information associated with the credential, and the user account engine 130 can identify the user 102 and/or a user account associated with the user 102 that corresponds to the credential. For instance, the user account engine 130 can receive the information associated with the credential that has been transmitted over the network 150 by the authentication engine 140. In some implementations, the user account engine 130 can receive the information associated with the credential directly from the merchant system 110, or from another component of the system 100. In some instances, the user account engine 130 can additionally or alternatively receive the information associated with the transaction performed by the user 102. Based on receiving the information associated with the credential and/or the transaction, the user account engine 130 can identify the user 102 and/or a user account associated with the user 102.

For instance, the user account engine 130 can receive information associated with the credential belonging to the user 102, and the user account engine 130 can access information associated with a user account that corresponds to the credential. Such information can identify personal information associated with the user 102, e.g., the name of the user 102, an address of the user 102, a date of birth of the user 102, a phone number of the user 102, physical attributes of the user 102, etc., can identify information associated with the user's 102 account, e.g., an account identification number, a card number associated with the account of the user 102, an available balance, available credit line or spending limit associated with the account of the user 102, a date when the account was opened, etc., and/or can identify one or more conditions associated with authenticating transactions performed by the user 102, e.g., particular regions where the credential may be used to perform transactions, times of day when the credential may be used to perform transactions, additional forms of identification that must be presented to authenticate transactions performed using the credential, etc.

Conditions associated with authenticating or performing transactions can, in some implementations, be dependent upon the transaction performed by the user 102. For example, the user account associated with the user 102 may identify different conditions associated with authenticating a transaction based on a monetary value associated with the transaction. The user account associated with the user 102, for example, may specify that there are no conditions that must be satisfied to authenticate a transaction for an amount of less than $20.00 USD, but may specify multiple conditions that must be satisfied to authenticate a transaction for an amount of more than $100.00 USD. Thus, authenticating a $10.00 USD transaction may not require any conditions to be satisfied aside from the user 102 providing the credential to the merchant, e.g., such that no additional time or location-based conditions must be satisfied. In such an instance, the $10.00 USD transaction may be authenticated based on receiving the information associated with the credential, e.g., at the authentication engine 140 or the user account engine 130. Alternatively, authenticating a transaction of $150.00 USD may require a number of conditions to be satisfied. For example, a predicted current location of the user 102 may be required to match a location associated with the transaction, and/or the user 102 may be required to provide a signature to the merchant system 110 that can be compared to a known signature of the user 102 for verification. Based on both of these conditions being met, the $150.00 USD transaction may then be authenticated. In practice, conditions associated with authenticating transactions performed by a user can differ depending on various other attributes of the transaction, e.g., based on the merchant, a location associated with the transaction, a time associated with the transaction, based on whether the transaction is a card present or a card not present transaction, etc.

Based on accessing information identifying the user account associated with the user 102, the user account engine 130 can transmit data that includes the information identifying the user account of the user 102. For instance, the user account information can be accessed at a database associated with the user account engine 130, and the user account engine 130 can transmit the user account information over the network 150.

The authentication engine 140 can receive the information identifying the user account associated with the user 102. For example, the authentication engine 140 can receive information identifying the user account that has been transmitted over the network 150 by the user account engine 130.

Based on receiving the information identifying the user account associated with the user 102, the authentication engine 140 can identify and/or access a social network profile associated with the user 102 that performed the transaction. For example, the authentication engine 140 can receive the information identifying a user account belonging to the user 102 from the user account engine 130, and can identify a social network profile associated with the user 102 based on the received user account information.

In some implementations, the authentication engine 140 can identify and/or access the social network account of the user 102 by using a name of the user 102 that is identified by the user account information. For example, the authentication engine 140 can submit the information associated with the credential to the user account engine 130, and can receive information from the user account engine 130 that identifies a name of the user 102 associated with the credential. Based on receiving the information that identifies the name of the user 102, the authentication engine 140 can identify and/or access a social network profile of the user 102, e.g., by identifying and/or accessing a social network profile associated with a name that matches the name of the user 102.

According to other implementations, the authentication engine 140 can identify and/or access the social network account of the user 102 based on other information. For example, the authentication engine 140 can receive information from the user account engine 130 that identifies the name of the user 102, and the authentication engine 140 can identify social network profile login information associated with the social network profile of the user 102. Based on identifying the social network profile login information of the user 102, the authentication engine 140 can identify and/or access the social network profile of the user 102.

The authentication engine 140 can identify and/or access the social network profile of the user 102 by communicating with the social network engine 120. For example, the authentication engine 140 can receive the information identifying the user account of the user 102, and can transmit information included in the user account of the user 102 to the social network engine 120 to identify and/or access the social network profile of the user 102. In some implementations, the authentication engine 140 can receive and transmit the information identifying the user account of the user and/or the information included in the user of the user 102 over the network 150.

Based on the authentication engine 140 transmitting information to the social network engine 120 to identify and/or access a social network profile of the user 102, the social network engine 120 can receive the information and can identify a social network profile of the user 102. For example, the social network profile 120 can receive information from the authentication engine 140 that identifies the name of the user 102. Based on receiving the information identifying the name of the user 102, the social network engine 120 can identify a social network profile that corresponds to the name of the user 102. In other implementations, the social network profile 120 can receive information from the authentication engine 140 that includes social network profile login information associated with a social network profile of the user 102, and the social network engine 120 can identify the social network profile of the user 102.

The social network engine 120 can transmit information to the authentication engine 140 that identifies and/or grants the authentication engine 140 access to the social network profile of the user 102. For example, the social network engine 120 can identify a social network profile of the user 102, and can transmit information that identifies and/or grants access to the social network profile of the user 102 to the authentication engine 140. The information identifying and/or granting access to the social network profile can be transmitting by the social network engine 120 to the authentication engine 140 over the network 150.

Based on receiving the information identifying and/or granting access to the social network profile of the user 102, the authentication engine 140 can access information at the social network engine 120 that can be used to perform social network based authentication of the transaction performed by the user 102. For example, the authentication engine 140 can access information at the social network engine 120 by communicating with the social network engine 120 over the network 150. In some implementations, the information accessed at the social network engine 120 by the authentication engine 140 can include information associated with the social network profile of the user 102 and/or location data that the user 102 has registered with the social networking platform associated with the social network engine 120. As described, the location data that has been registered with the social networking platform and that is associated with the social network profile of the user 102 can identify locations that the user 102 is, has been, or will be located. The accessed social network profile information and/or location data can be used to evaluate one or more location-based conditions associated with authenticating the transaction performed by the user 102.

In some implementations, the authentication engine 140 can access the information at the social network engine 120 based on determining that the transaction cannot be authenticated based only on the received information associated with the transaction and the information associated with the user account of the user 102. For example, the authentication engine 140 can receive information associated with the transaction and information identifying a user account associated with the user 102, where the user account identifies a condition associated with performing transactions that requires the transaction to be performed within a particular region of the United States. Based on the authentication engine 140 determining that the information associated with the transaction does not specify the particular region of the United States as the location where the transaction was performed by the user 102, the authentication engine 140 can determine to access information at the social network engine 120, such as location data associated with the social network profile of the user 102. The authentication engine 140 can access the information at the social network engine 120 in order to perform social network based authentication of the transaction performed by the user 102.

According to other implementations, the authentication engine 140 can access information at the social network engine 120 for every transaction. For example, even if information received from the user account engine 130 that is associated with the user account of the user 102 satisfies one or more conditions associated with authenticating a transaction performed by the user 102, the authentication engine 140 may access information at the social network engine 120, such as location data associated with the social network profile of the user 102. In such instances, accessing the information at the social network engine 120 can enable the authentication engine 140 to confirm the location of the user 102, thereby further enhancing the confidence with which the authentication engine 140 can authenticate the transaction performed by the user 102.

For example, information associated with a transaction and received at the authentication engine 140 may satisfy one or more conditions associated with authenticating the transaction, e.g., a location associated with the transaction may correspond to a permissible location for performing transactions. The authentication engine 140 may access information at the social network engine 120 that further supports authentication of the transaction, e.g., by accessing information at the social network engine 120 that indicates a likely location of the user 102, where the authentication engine 140 determines that the likely location of the user 102 corresponds to the location of the transaction. In another example, the information accessed at the social network engine 120 may indicate that the user 102 is likely located at a location that does not correspond to the location of the transaction. In such an instance, the authentication engine 140 may determine not to authenticate the transaction, based on determining that the user 102 is likely at a location that is different from the location of the transaction and therefore indicating that the transaction may be fraudulent.

In still other implementations, the authentication engine 140 can access information at the social network engine 120 based on one or more other triggers, or based on one or more characteristics of the transaction performed by the user 102. For example, the authentication engine 140 may access information at the social network engine 120 to perform social network based transaction authentication based on a transaction being performed at a particular time of day, such as between the hours of 12:00 AM and 5:00 AM, based on a threshold number of transactions being performed within a predetermined period of time, e.g., if more than three transactions are performed within a twenty four hour period, based on a transaction being for at least a certain monetary amount, e.g., based on the transaction being for an amount of more than $100.00 USD, or based on any other trigger or characteristic associated with the transaction.

In some implementations, the authentication engine 140 can access information at the social network engine 120 that identifies personal information associated with the user 102 and that has been registered with the social network profile of the user 102. Additionally or alternatively, the authentication engine 140 can access other information at the social network engine 120 that has been registered with the social networking platform in association with the social network profile of the user 102, e.g., location data associated with the user 102. As described, the authentication engine 140 can access the information at the social network engine 120 by providing information to the social network engine 120 that grants the authentication engine 140 access to the information. In some implementations, the authentication engine 140 can access the information at the social network engine 120 based on providing information that identifies the user 102 and/or that identifies the social network profile associated with the user 102. In some implementations, the authentication engine 140 can transmit information associated with logging into the social network profile of the user 102, such as a user name and password associated with the social network profile of the user 102. In some implementations, the authentication engine 140 can transmit information to the social network engine 120 that indicates that the user 102 has permitted the authentication engine 140, or an application associated with the authentication engine 140, to access the social network profile of the user 102 and/or to access the location data associated with the social network profile of the user 102.

The authentication engine 140 can access information at the social network engine 120 associated with the user 102. For example, the authentication engine 140 can access information that identifies the user 102, as well as additional information relating to the user 102, e.g., the user's 102 age, physical characteristics, relationship status, hometown, current location of residence, employer, interests, one or more endorsements that the user 102 has registered with the social networking platform, other users that are a part of the user's 102 social network, one or more images of the user 102, and other information. In some implementations, the authentication engine 140 can access the information associated with the social network profile of the user 102 based on being granted access to the information, e.g., by the social network engine 120. For example, the authentication engine 140 can submit information to the social network engine 120 as a part of a request to access the information, and based on the request being granted, e.g., by the social network engine 120, the authentication engine 140 can access the information associated with the social network profile of the user 102.

The authentication engine 140 can additionally or alternatively access location data that is associated with the social network profile of the user 102. In some implementations, location data associated with the social network profile of the user 102 can include information that has been registered with the social networking platform from the social network profile of the user 102 and/or that identify the social network profile of the user 102.

For example, the location data associated with the social network profile of the user 102 can include a user-provided current location of residence, a place of employment, place of education, hometown, locations of residence of members of the user's 102 social network, locations of businesses or other entities that have been endorsed through the social networking platform, locations associated with or identified from messages, posts, comments, or other communications registered with the social networking platform, images, videos, or other content items posted to the social networking platform that are associated with or identify locations and that identify the social network profile of the user 102, “check-ins” that identify the social network profile of the user 102 and one or more locations, events that the user 102 is attending or hosting and that are associated with locations, or any other information received and/or registered at the social networking platform that identifies a location and the social network profile of the user 102. In some implementations, the authentication engine 140 can access the location data based on the authentication engine 140 being granted access to the location data. For example, the authentication engine 140 can submit information to the social network engine 120 as a part of a request to access the location data associated with the social network profile of the user 102, and based on the request being granted, e.g., by the social network engine 120, the authentication engine 140 can access the location data that is associated with the social network profile of the user 102.

While described thus far in terms of the authentication engine 140 accessing information at the social network engine 120, e.g., based on the authentication engine identifying and/or being granted access to a social network profile of the user 102, in some implementations, the social network engine 120 can transmit information to the authentication engine 140. For example, the social network engine 120 can receive information from the authentication engine 140 and can identify a social network profile associated with the user 102. Based on identifying the social network profile associated with the user 102, the social network engine 120 can transmit information to the authentication engine 140, where the transmitted information can include information associated with the social network profile of the user 102 and/or location data associated with the social network profile of the user 102.

In some instances, the authentication engine 140 can access the information associated with the social network profile of the user 102 and/or the location data associated with the social network profile of the user 102, and the authentication engine 140 can store the information associated with the social network profile of the user 102 and/or the location data associated with the network profile of the user 102. For example, the authentication engine 140 can be associated with a database, and the authentication engine 140 can store the information associated with the social network profile of the user 102 and the location data associated with the social network profile of the user 102 at the database associated with the authentication engine 140. In some instances, the authentication engine 140 can additionally or alternatively store the information identifying the transaction performed by the user 102 and/or the information identifying the user account belonging to the user 102 at the database associated with the authentication engine 140.

In some implementations, storing the information associated with the social network profile of the user 102, the location data associated with the social network profile of the user 102, the information associated with the transaction, and/or the information identifying the user account associated with the user 102 such that the information is available for future access. For example, the authentication engine 140 can store the information such that subsequent transactions performed by the user 102 can be authenticated by using social network based transaction authentication without the need to access information at the user account engine 130 and/or the social network engine 120. In such instances, the information stored at the database associated with the authentication engine 140 can be stored such that the necessary information is accessible by the authentication engine 140 when the authentication engine 140 receives information associated with another transaction performed by the user 102. For instance, after storing the information, the authentication engine 140 can receive information from a merchant system 110 that is associated with a different transaction performed by the user 102. Based on receiving the information associated with the different transaction, e.g., information that includes information associated with the transaction and information associated with a credential, the authentication engine 140 can access information at the database associated with the authentication engine 140 that identifies a user account belonging to the user 102, information associated with a social network profile of the user 102, and/or location data associated with the social network profile of the user 102. The authentication engine 140 can utilize the accessed information to perform social network based authentication of the transaction.

In some implementations, the authentication engine 140 can identify information that has been stored at the database associated with the authentication engine 140, and can identify, access, and/or receive only relevant data that is not already stored at the database associated with the authentication engine 140. For example, the authentication engine 140 can identify information associated with a user account belonging to the user 102, information associated with a social network profile of the user 102, and location data associated with the social network profile of the user 102 that is stored at the database associated with the authentication engine 140. The authentication engine 140 can also identify information that is accessible by the authentication engine 140 and that is not stored at the database associated with the authentication engine 140, for example, information associated with a user account belonging to the user 102 that is accessible at the user account engine 130, information associated with a social network profile of the user 102 that is accessible at the social network engine 120, and/or location data associated with a social network profile of the user 102 that is accessible at the social network engine 120. The authentication engine 140 can access the information that is accessible and that is not stored at the database associated with the authentication engine 140, and can optionally store the accessed information at the database associated with the authentication engine 140.

In some implementations, the authentication engine 140 can access and store information at the associated database based on receiving data associated with a transaction performed by the user 102. In other implementations, the authentication engine 140 can access and store the information based on detecting other trigger events, e.g., periodically with time, based on receiving an indication that information associated with the user account belonging to the user 102, information associated with the social network profile of the user 102, and/or location data associated with the social network profile of the user 102 has been updated, etc.

Based on the authentication engine 140 having accessed information that identifies the user account belonging to the user 102, information associated with the transaction performed by the user 102, information associated with the social network profile of the user 102, and/or location data associated with the social network profile of the user 102, analysis can be performed to determine whether to authenticate the transaction. In some instances, performing analysis to determine whether to authenticate the transaction performed by the user 102 can involve identifying one or more location-based conditions associated with authenticating the transaction performed by the user 102, and, based on the received information, determining whether to authenticate the particular transaction.

For example, information associated with the user account belonging to the user 102 may specify that transactions performed by the user 102 may only be authenticated within a particular region of the United States, or within a threshold distance, e.g., fifty miles, of a location identified as a likely current location of the user 102. The authentication engine 140 may identify a likely current location of the user 102 by accessing the location data associated with the social network profile of the user 102 and identifying a likely current location of the user 102 based on the location data.

For example, information associated with a transaction may indicate that the transaction is being performed from a location in Rome, Italy, and location data associated with the social network profile of the user 102 may indicate that the user 102 was located in Rome, Italy within the past week. Based on the location data, the authentication engine 140 may determine that the user 102 is likely located in Rome, Italy. Based on determining that the location of the transaction matches a likely location of the user 102, the authentication engine 140 may determine that the location-based condition associated with authenticating the transaction is satisfied. For example, the authentication engine 140 may determine that the location data indicating that the user 102 has been identified within 50 miles of the Rome, Italy within the past week satisfies the location-based condition associated with the authenticating the transaction, and may determine to authenticate the transaction performed by the user 102.

In some implementations, the information associated with the transaction, the information associated with the user account belonging to the user 102, the information associated with the social network profile of the user 102, and/or the location data associated with the social network profile of the user 102 can be transmitted to the authentication engine 140, and the authentication engine 140 can perform analysis to determine whether to authenticate the transaction. In other implementations, the information associated with the user account belonging to the user 102, the information associated with the social network profile of the user 102, and/or the location data associated with the social network profile of the user 102 can be transmitted to the user account engine 130, the social network engine 120, or the merchant system 110, e.g., by the authentication engine 140, and the user account engine 130, social network engine 120, or merchant system 110 can perform analysis to determine whether to authenticate the transaction performed by the user 102.

Based on determining whether to authenticate the transaction, a response is provided that indicates whether the transaction or transaction request has been authenticated. For example, the authentication engine 140 can determine whether to authenticate the transaction, and can transmit information to the merchant system 110 indicating whether the transaction has been authenticated.

The merchant system 110 can receive the information indicating whether the transaction has been authenticated, and the merchant system 110 can perform operations to process the transaction or to decline the transaction, based on the received information. For example, based on the merchant system 110 receiving information indicating that the transaction has been authenticated, the merchant system 110 can perform operations to process the transaction performed by the user 102. Alternatively, based on the merchant system 110 receiving information indicating that the transaction has not been authenticated, the merchant system 110 can perform operations to decline the transaction performed by the user 102.

In some implementations, information transmitted to the merchant system 110 that indicates whether a transaction performed by the user 102 has been authenticated can further include information indicating or that can be used to determine whether to process or decline the transaction. For example, in addition to transmitting information indicating whether the transaction performed by the user 102 has been authenticated, the authentication engine 140 can transmit information that indicates whether the transaction has been approved or declined, or can transmit information that can be used by the merchant system 110 to determine whether to approve or decline the transaction.

For example, according to one implementation, the authentication engine 140 can receive information indicating one or more other conditions associated with approving transactions performed by the user 102, in addition to the one or more conditions associated with authenticating transactions performed by the user 102. For instance, the user account engine 130 can transmit information to the authentication engine 140 that identifies one or more conditions associated with approving the transaction performed by the user 102, e.g., a maximum available line of credit associated with the user account belonging to the user 102, an expiration date of a credit card associated with the user account, permissible times when the user 102 may perform transactions using the user account, etc.

The authentication engine 140 can evaluate the transaction based on the one or more conditions associated with approving transactions identified by the user account engine 130. For example, the authentication engine 140 can determine whether the information associated with the transaction satisfies the one or more conditions, e.g., whether the time associated with the transaction satisfies an acceptable range of times for performing transactions, whether a monetary amount associated with the transaction is less than or equal to the available line of credit associated with the user account of the user 102, etc. Based on authenticating the transaction and determining that the one or more conditions associated with approving the transaction are satisfied, the authentication engine 140 can transmit information, for example, to the merchant system 110, indicating that the transaction is approved. Alternatively, based on the transaction or transaction request not being authenticated, and/or based on determining that one or more of the conditions associated with approving transaction are not satisfied, the authentication engine 140 can transmit information indicating that the transaction is declined.

In other implementations, other components of the system 100 can perform operations to determine whether to approve a transaction performed by the user 102. For example, the authentication engine 140 can transmit data indicating whether the transaction performed by the user 102 has been authenticated to the user account engine 130, and the user account engine 130 can evaluate one or more conditions associated with approving the transaction. For instance, the user account engine 130 can receive information associated with the transaction, e.g., information identifying a monetary amount associated with the transaction, a time associated with the transaction, etc., and the user account engine 130 can evaluate whether the transaction satisfies the one or more conditions. Based on receiving information from the authentication engine 140 indicating whether the transaction or transaction request has been authenticated, the user account engine 130 can then transmit information to the authentication engine 140 and/or directly to the merchant system 110 that indicates whether the transaction is approved.

In some implementations, the user account engine 130 can determine whether to approve the transaction performed by the user 102 without receiving the information indicating whether the transaction has been authenticated. For example, the authentication engine 140 can determine whether to authenticate the transaction, and the user account engine 130 can determine whether to approve the transaction. Based on the transaction being both approved by the user account engine 130 and authenticated by the authentication engine 140, information can be transmitted to the merchant system 110 indicating that the merchant system 110 should process the transaction. Based on one or more of the user account engine 130 declining the transaction or the authentication engine 140 not authenticating the transaction, however, the merchant system 110 can receive information indicating that the merchant system 110 should not process the transaction performed by the user 102.

In another implementation, the merchant system 110 can receive information indicating whether the transaction has been authenticated as well as information identifying one or more conditions associated with approving the transaction. For example, the merchant system 110 can receive information, e.g., from the authentication engine 140, indicating whether the transaction has been authenticated, and can additionally receive information, e.g., from the user account engine 130 or the authentication engine 140, that identifies one or more conditions associated with approving transactions performed by the user 102. The merchant system 110 can evaluate the one or more conditions associated with approving the transaction performed by the user, and can determine whether to process the transaction based on the evaluation of the one or more conditions.

The merchant system 110, social network engine 120, user account engine 130, and authentication engine 140 can each be implemented using any suitable computer, server, or collection of computers or servers executing software that is capable of processing and managing data. In some implementations, the merchant system 110, social network engine 120, user account engine 130, and authentication engine 140 can access data and perform operations over one or more network connections, such as one or more connections to the network 150. In practice, the network 150 can be one or more LANs, e.g., Wi-Fi, or WANs, such as the Internet, and the merchant system 110, social network engine 120, user account engine 130, and authentication engine 140 can connect to the network 150 using one or more wired or wireless connections.

The social network engine 120 associated with the social networking platform can be associated with a database used for storing information provided by users of the social networking platform, including information relevant to performing social network based transaction authentication. For example, the social network engine 120 can store, at the associated database, information identifying users of the social networking platform, information associated with social network profiles of the users of the social networking platform, and location data associated with the social network profiles of the users of the social networking platform. Location data, as described, can include a user's current location of residence, place of employment, place of education, home town, locations of residence of members of a user's social networks, locations of businesses and other entities that a user has endorsed, locations associated with interests of a user, locations associated with messages, comments, or other posts, “check-ins,” images, videos, or other content registered with the social networking platform, or other information received at the social network engine 120 that identifies a location in reference to one or more users of the social networking platform, e.g., one or more social network profiles associated with users of the social networking platform.

The user account engine 130 can be associated with a database used for storing information relevant to user accounts associated with users, such as the user 102. For example, the user account engine 130 can store, at the associated database, information identifying user accounts and information associated with user accounts, such as names of users associated with user accounts, personal information of users associated with the user accounts, e.g., addresses, phone numbers, physical attributes, financial information, medical information, etc., information associated with credentials identifying the user accounts, e.g., account numbers, card numbers, card expiration dates, card security codes, card personal identification numbers (PIN), signatures of users, images of users, conditions or information associated with the use of user accounts to perform transactions, e.g., locations where transactions can be completed, an account balance, available line of credit, times when the user account can be accessed or transactions completed, etc., and other relevant information.

The authentication engine 140 can be associated with a database that stores information that is relevant to authenticating transactions, including information associated with performing social network based transaction authentication. For example, the authentication engine 140 can store, at the associated database, information associated with user accounts and information associated with authenticating transactions performed in association with those user accounts, such as location data identifying locations that a user associated with a user account is, has been, or will be located, locations where a user can perform transactions, a signature of a user that can be used to determine whether a particular signature provided in association with a transaction is that of the user, a PIN corresponding to a credential associated with a user account, or other information useful for performing transaction authentication, including social network based transaction authentication. In some instances, the database associated with the authentication engine 140 can store information identifying one or more conditions associated with authenticating transactions performed by a user associated with a user account, such as one or more conditions associated with authenticating transactions performed by a user associated with a user account that have been received from the user account engine 130.

While depicted in FIG. 1 as separate entities, in some instances, one or more components of the system 100 can be integrated or further subdivided into separate entities. For example, the merchant system 110 and authentication engine 140 may be integrated into a single component, the user account engine 130 and authentication engine 140 may be integrated, or the social network engine 120 and authentication engine 140 may be integrated. In such instances, the integrated or subdivided components of the system 100 can communicate using the network 150, for example, by connecting to the network 150 over one or more wired or wireless connections.

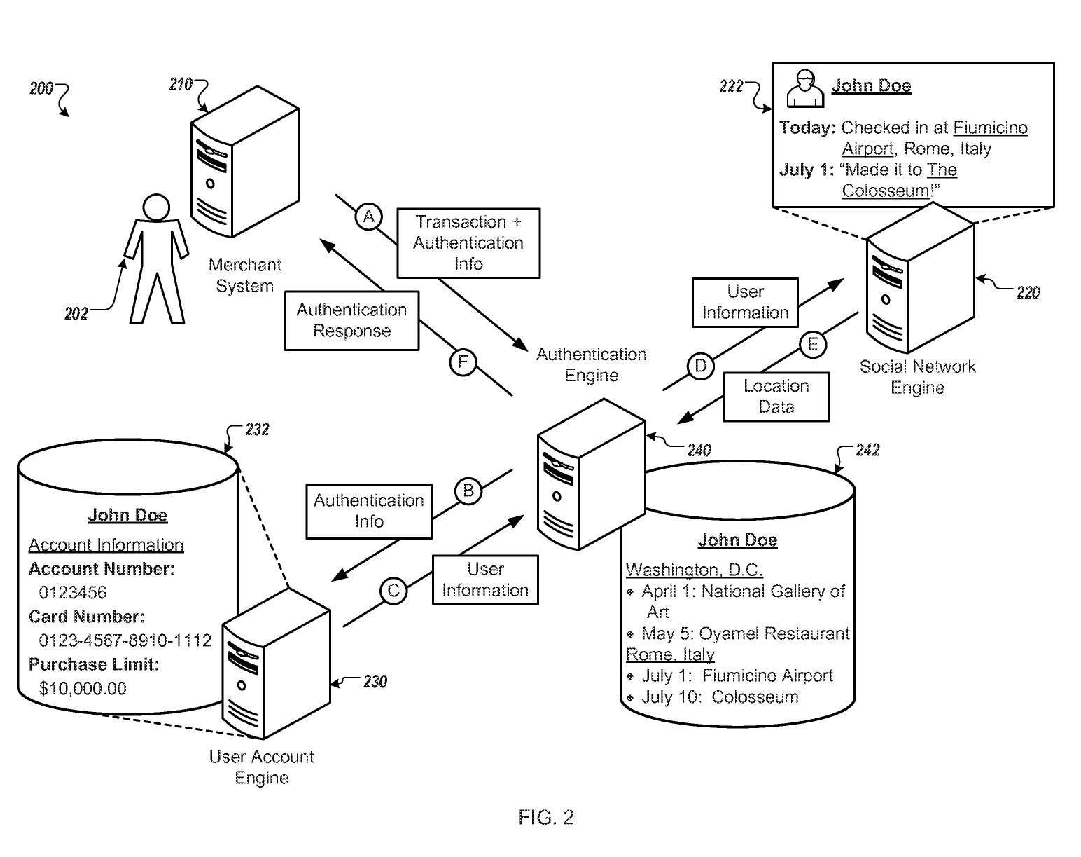

FIG. 2 illustrates an example system 200 for performing social network based transaction authentication. Specifically, the system 200 can enable a transaction performed by a user to be authenticated, where authentication of the transaction can be achieved by performing social network based transaction authentication.

Briefly, the system 200 can perform social network based transaction authentication by obtaining information associated with a transaction performed by a user, accessing social network data associated with a social network profile of the user, and authenticating the transaction based on the social network. The system 200 includes a merchant system 210, a social network engine 220, a user account engine 230, and an authentication engine 240. The components of the system 200 can each be in communication over one or more networks, such as the network 150, or can be in communication through one or more other wired or wireless connections.

In greater detail, the merchant system 210 is in communication with the authentication engine 240 over one or more networks. The merchant system 210 can be any system capable of receiving information associated with transactions and can communicate with other systems to authenticate the transactions. For example, the merchant system 210 can be a network-enabled card reader device, an application associated with a card reader device, an application accessible over a network, a website or other web-based application or resource, a network-enabled mobile device, or any other system capable of receiving information associated with transactions and submitting the information associated with the transactions for authentication.

The merchant system 210 can receive information associated with a transaction and information associated with authenticating the transaction. For example, a user 202 can visit a physical location of a merchant, e.g., a physical store that a merchant operates, and can perform a transaction to purchase a good from the merchant. In association with performing the transaction, the user 202 can provide additional information associated with authenticating the transaction. Information associated with the transaction and additional information associated with authenticating the transaction can be transmitted by the merchant system 210 to the authentication engine 240 during operation (A).

For example, information associated with a transaction can include information identifying a merchant, one or more products or services associated with the transaction, information identifying a monetary value associated with the transaction, a time and date associated with the transaction, a location associated with the transaction, an indication of whether the transaction was a card present or a card not present transaction, an indication of whether the transaction was performed online, e.g., using a website associated with the merchant, or performed in-store, e.g., at a brick and mortar location of the merchant, and/or other information relevant to the transaction and/or performing the transaction. In some instances, the information associated with the transaction can be determined and/or provided by the merchant and/or the merchant system 210, can be determined and/or provided by the user 202 performing the transaction, or can be determined and/or provided by a combination of these elements.

Information associated with authenticating the transaction can include information identifying the user 202, such as information identifying the user's 202 name, address, age or date of birth, gender, physical characteristics, and other identifying information, e.g., a Social Security number of the user 202. The information can also include information identifying a user account belonging to the user 202, such as information identifying a credit account or debit account used to perform the transaction. For example, the information can identify a financial institution with whom the user 202 maintains a user account, e.g., the credit card issuer or bank used by the user 202, an account number identifying the user account of the user 202, security and/or expiration data associated with a credential that identifies the user account of the user 202, e.g., a PIN associated with a credit or debit card, a security code associated with a credit or debit card, a signature of the user 202, an expiration date associated with a credit or debit card, and other information used to authenticate a transaction performed by the user 202.

In some instances, the information associated with authenticating the transaction can be provided to the merchant system 210 in the form of a credential associated with the user 202. In some instances, the credential can identify a user account belonging to the user 202. For example, the user 202 can have a credential in the form of a credit card, debit card, check card, gift card, user account login information, or other form that identifies a user account belonging to the user 202, and the user 202 can present the credential to a merchant in association with performing a transaction.

The information associated with the credential can be provided to the merchant system 210 using a variety of methods. For example, a merchant can perform a card swipe operation using a credit card, debit card, or gift card at a card reader device, can enter information identifying or associated with logging into a user account, e.g., by manually typing in an email address associated with the user account belonging to the user 202 or by manually entering credit card information for a credit account belonging to the user 202, or can enable a user to enter login information associated with their user account. The merchant system 210 can receive the information associated with the credential, and can use the information associated with the credential in authenticating the transaction performed by the user 202.

The merchant system 210 can receive the information associated with the transaction performed by the user 202 and the information associated with authenticating the transaction, and can transmit the information associated with the transaction and the information associated with authenticating the transaction to the authentication engine 240 during operation (A). For example, a user 202 can perform a transaction by providing a credit card to a merchant, and the merchant can enter information associated with the transaction and the credit card at a merchant system 210. The merchant system 210 can then transmit information associated with the transaction and the credit card of the user 202 to the authentication engine 240. Optionally, the merchant system 210 can identify information associated with the transaction and/or the authentication of the transaction, e.g., a time and location associated with the transaction, and can include the information in the transmission to the authentication engine 240. In some implementations, the information associated with the transaction and information associated with authenticating the transaction can be transmitted to the authentication engine 140 over one or more networks, such as the network 150.

The authentication engine 240 receives the information associated with the transaction and the information associated with authenticating the transaction. For example, the authentication engine 240 receives the information associated with the transaction and the information associated with authenticating the transaction from the merchant system 210 over the network 150. In some implementations, the authentication engine 240 receives the information associated with the transaction and the information associated with authenticating the transaction in a single data packet, e.g., based on the merchant system 210 combining the information into a single data packet for transmission, or receives the information associated with the transaction and the information associated with authenticating the transaction in multiple data packets, e.g., based on the merchant system 210 transmitting the information separately and/or at different times to the authentication engine 240.

The authentication engine 240 can transmit information that is associated with authenticating the transaction to the user account engine 230 during operation (B). For example, the authentication engine 240 can transmit information associated with the transaction and/or other information associated with authenticating the transaction to the user account engine 230 over one or more networks, such as the network 150. The authentication engine 240 can transmit the information to the user account engine 230 based on receiving the information from the merchant system 210. In some implementations, the authentication engine 240 can transmit the information to the user account engine 230 as a single data packet, e.g., at a single time, or as multiple data packets, e.g., separately and/or at different times.

In some instances, the information provided to the user account engine 230 by the authentication engine 240 can include information that enables the user account engine 230 to identify the user 202, a user account belonging to the user 202 that was used to perform the transaction, and/or a social network profile associated with the user 202. For example, the authentication engine 240 can receive the information associated with the transaction and the information associated with authenticating the transaction from the merchant system 210, and can transmit information to the user account engine 230 that can be used to identify the user 202, a user account belonging to the user 202 used to perform the transaction, and/or a social network profile of the user 202.

The information transmitted to the user account engine 230 can include information associated with authenticating the transaction performed by the user 202. For example, the information transmitted to the user account engine 230 can include information identifying the user 202, such as information identifying the user's 202 name, address, age or date of birth, gender, physical characteristics, or other identifying information, e.g., a Social Security number of the user 202. The information transmitted to the user account engine 230 can additionally or alternatively include information identifying or associated with a user account belonging to the user 202, such as information identifying a financial institution with whom the user 202 maintains an account, an account number identifying a user account belonging to the user 202, security and/or expiration data associated with a credential that is associated with the user account of the user 202, or other information used to authenticate a transaction or to identify the user 202 and/or a user account belonging to the user 202. In some implementations, the information transmitted to the user account engine 130 can include information associated with a credential held by the user 202, where the information associated with the credential can be used to identify the user 202 and/or a user account belonging to the user 202.

The information transmitted to the user account engine 230 can additionally or alternatively include information associated with the transaction. For instance, the information transmitted to the user account engine 230 by the authentication engine 240 can include information identifying the merchant associated with the transaction, one or more products or services associated with the transaction, a monetary value associated with the transaction, a time and date associated with the transaction, a location associated with the transaction, an indication of whether the transaction was a card present or a card not present transaction, etc.

In some implementations, prior to transmitting the information to the user account engine 230, the authentication engine 240 identifies a subset of the information received from the merchant system 210 that is relevant to identifying the user 202, a user account associated with the user 202, and/or a social network profile of the user 202, and transmits only the relevant information to the user account engine 230. For example, the authentication engine 230 can identify, from among the information received from the merchant system 210, information associated with a credential that belongs to the user 202 and that is associated with a user account of the user 202, and can transmit only the information associated with the credential to the user account engine 230.

In some implementations, the authentication engine 240 accesses a data store 242 associated with the authentication engine 240 prior to transmitting the information to the user account engine 230. The authentication engine 240 can determine whether to transmit information to the user account engine 230 and/or can identify the information to transmit to the user account engine 230 based on information accessed at the data store 242.

For example, the data store 242 associated with the authentication engine 240 can include information that identifies users, user accounts belonging to the users, social network profiles associated with the user, and/or other information associated with authenticating transactions performed by users. As an example, the data store 242 can include information that identifies the user 202, can include information that identifies a user account belonging to the user 202, can include information that identifies a social network profile associated with the user 202, and/or can include location data that identifies locations where the user 202 has been located, is located, or will be located. The authentication engine 240 can access the data store 242 and can determine information to transmit to the user account engine 230 based on the information stored at the data store 242.

For instance, the authentication engine 240 can receive information associated with a transaction and information associated with authenticating the transaction. The authentication engine 240 can access the data store 242 and can identify information stored at the data store 242 based on the received information. The authentication engine 240 can determine information to transmit to the user account engine 230 based on the information accessed at the data store 242. For instance, based on identifying the user 202 or a user account associated with the transaction, the authentication engine 240 can determine to transmit information to the user account engine 230 that includes information identifying the user 202 or the user account associated with the transaction, in addition to, in combination with, or in lieu of the information associated with authenticating the transaction and/or the information associated with the transaction.

The user account engine 230 can receive the information from the authentication engine 240, and based on the received information can identify the user 202, a user account belonging to the user 202, and/or a social network profile associated with the user 202. The user account engine 230 can transmit information to the authentication engine 240 that identifies the user 202, the user account belonging to the user 202, and/or the social network profile of the user 202 during operation (C).

In some implementations, the user account engine 230 can additionally or alternatively identify conditions associated with authenticating transactions performed by the user 202, and/or can identify other information associated with authenticating transactions performed by the user 202, e.g., other information identified by a user account belonging to the user 202. In some implementations, the user account engine 230 can identify information associated with processing a transaction performed by the user 202, such as an available line of credit associated with the user account used by the user 202 to perform the transaction.

For example, the user account engine 230 can receive information associated with authenticating a transaction performed by the user 202, and can identify a user account belonging to the user 202 based on the received information. The user account engine 230 can identify a user account belonging to the user 202 by accessing a data store 232 associated with the user account engine 230. The data store 232 can include information identifying and associated with user accounts, such as information identifying and associated with the user account belonging to the user 202. In some instances, the data store 232 can include user accounts for a number of different user account issuers, e.g., a number of different commercial banks, or can include user accounts that are specific to a particular account issuer, e.g., a particular commercial bank.

In some instances, the user account engine 230 can be associated with multiple data stores, where each of the multiple data stores are associated with specific account issuers and/or with a subset of the stored user accounts, e.g., with a subset of all user accounts stored by the data stores. The user account engine 230 can identify a particular data store based on the information received from the authentication engine 240, and can determine to access the identified data store. The user account engine 230 can identify a user account belonging to the user 202 based on accessing the particular identified data store.

As an example, the user account engine 230 can receive information associated with authenticating a transaction performed by the user 202, and can identify the user 202, a user account belonging to the user 202, and/or a social network profile associated with the user 202 based on the received information. For instance, the information associated with authenticating a transaction performed by the user 202 can include an account number obtained from a credential provided by the user 202 to perform the transaction. The user account engine 230 can access the data store 232, and can identify the user 202, a user account belonging to the user 202, and/or a social network profile associated with the user 202 based on the information that includes the account number.

In some implementations, the user account engine 230 can identify the user 202, a user account belonging to the user 202, and/or a social network profile associated with the user 202 by querying the data store 232 to identify users, user accounts, or social network profiles that correspond to the information received from the authentication engine 240. For example, based on receiving information that identifies a credit card number submitted by the user 202 to perform the transaction, e.g., the credit card number “0123-4567-8910-1112” shown in FIG. 2, the user account engine 230 can query the data store 232 for the credit card number “0123-4567-8910-1112.” Based on the query, the user account engine 230 can determine that the credit card number “0123-4567-8910-1112” is associated with a credit card account belonging to a user named “John Doe.” The user account engine 230 can additionally determine that the credit card number “0123-4567-8910-1112” is associated with a user account having the account number “0123456” and that the user account has a credit limit of $10,000.00. In some implementations, the user account engine 230 can identify additional information associated with the user identified as “John Doe” or the user account belonging to the user “John Doe,” such as a social network profile of the user “John Doe” or personal information of the user “John Doe.”

In some implementations, based on identifying the user account associated with the user 202, the user account engine 230 can identify one or more conditions that must be satisfied in order to authenticate a transaction performed using the user account. Other information can be identified that is associated with the user account, e.g., information that includes a signature of the user who owns the user account, information associated with a balance, purchase history, maximum line of credit or available line of credit, an expiration date of a credit card or other credential associated with the user account, etc.

Similarly, based on identifying a social network profile of the user 202, the user account engine 230 can identify information associated with the social network profile of the user 202. Such information can include, for example, information required to log in to the social network profile of the user 202, information identifying a social network associated with the social network profile, and/or other information.

In some instances, information received at the user account engine 230 can be compared to user account information stored at the data store 232, and the user account engine 230 can identify two or more user accounts that correspond to the received information. In such instances, the user account engine 230 can identify a particular user account that best matches the received information, e.g., a user account belonging to a user that is associated with information that best matches the received information. In other instances, based on the user account engine 230 identifying more than one user account corresponding to the received information, the user account engine 230 can determine not to identify a particular user account, e.g., such that the received information is deemed inconclusive or insufficient to identify a particular user account. In some implementations, similar methods can be employed based on the user account engine 230 identifying two or more users or two or more social network profiles based on the received information.

Based on identifying the user 202, a particular user account belonging to the user 202, and/or a social network profile of the user 202, the user account engine 230 can transmit information associated with the user 202, the user account belonging to the user 202, and/or the social network profile of the user 202 to the authentication engine 240 at operation (C). For example, the user account engine 230 can transmit information to the authentication engine 240 that identifies a credit account belonging to the user 202, identified as the user “John Doe,” personal information of the user “John Doe,” one or more conditions associated with authenticating transactions performed by the user “John Doe” using the credit account, information identifying a social network profile of the user “John Doe,” information relevant to logging in to the social network profile of the user “John Doe,” etc. In some implementations, the user account engine 230 can transmit the information to the authentication engine 240 over one or more networks, such as the network 150.

The authentication engine 240 can receive the information from the user account engine 230. For example, the authentication engine 240 can receive the information identifying a credit account of the user “John Doe,” personal information of the user “John Doe,” one or more conditions associated with authenticating transactions performed by the user “John Doe” using the credit account, and/or the information identifying the social network profile of the user “John Doe.” In some instances, the authentication engine 240 can receive the information over one or more networks, such as the network 150.

Based on receiving the information from the user account engine 230, at step (D) the authentication engine 240 can transmit information to the social network engine 220 to access information associated with a social network profile of the user 202 and/or location data associated with a social network profile of the user 202. Accessing the information and/or location data can enable the authentication engine 240 to perform social network based transaction authentication. For example, the authentication engine 240 can transmit information identifying a social network profile of the user 202 and/or login information associated with accessing a social network profile of the user 202 to the social network engine 220. In some implementations, the authentication engine 240 can transmit the information over one or more networks, such as the network 150.

In some implementations, the authentication engine 240 can determine to access information at the social network engine 220 based on the information received from the user account engine 230 or based on performing analysis on the information received from the user account engine 230. For example, the authentication engine 240 can receive information identifying the user 202, a user account belonging to the user 202, one or more conditions associated with authenticating transactions performed by the user 202, and/or a social network profile of the user 202, and can determine to access information at the social network engine 220 based on the received information.

In some instances, the authentication engine 240 can access the information at the social network engine can based on determining that the information received from the user account engine 230 is insufficient to perform social network based transaction authentication. For example, the authentication engine 240 can determine to access information associated with authenticating the transaction performed by the user 202 based on the information received from the user account engine 230 indicating that the transaction performed by the user 202 requires one or more conditions to be satisfied. A condition associated with authenticating a transaction may require, for example, that a location associated with the transaction correspond to a predicted current location of the user 202, where the predicted current location of the user 202 is determined based on location data associated with the social network profile of the user 202.

As an example, information associated with a transaction performed by the user 202 and received at the authentication engine 240 can indicate that a transaction was performed from a location in Rome, Italy, and a condition associated with approving the transaction may indicate that a predicted current location of the user 202 must match the location of the transaction. Based on the received information, the authentication engine 240 can determine to access information associated with the social network profile of the user 202 at the social network engine 220, such as location data associated with the social network profile of the user 202. The authentication engine 240 can predict a current location of the user 202 based on the accessed location data and can evaluate the condition associated with approving the transaction by comparing the predicted current location of the user 202 to the location in Rome, Italy.

As another example, information associated with a transaction performed by the user 202 and received at the authentication engine 240 can indicate that the transaction is associated with a monetary value of $10.00 USD, and information received at the authentication engine 240 from the user account engine 230 can indicate that a predicted current location of the user 202 must match the location of the transaction if the transaction is associated with a monetary value of greater than $20.00 USD. The authentication engine 240 can perform analysis to determine that the transaction performed by the user 202 does not exceed the $20.00 USD threshold amount, and can therefore determine to bypass accessing information at the social network engine 220. For example, the authentication engine 240 can determine whether to authenticate the $10.00 USD transaction based on other information received from the merchant engine 210 and/or the user account engine 230.

In some implementations, the authentication engine 240 can access information at the data store 242 associated with the authentication engine 240 based on the information received from the user account engine 230. For example, the authentication engine 240 can receive information from the user account engine 230 that identifies the user 202, a user account belonging to the user 202, personal information of the user 202, one or more conditions associated with authenticating transactions performed by the user 202, and/or a social network profile of the user 202, and the authentication engine 240 can access information at the data store 242 based on receiving the information. In some implementations, the data store 242 can be queried, where a query can identify information included in the information received from the user account engine 230. For instance, based on receiving information identifying the user “John Doe,” the authentication engine 240 can query the data store 242 for the user “John Doe,” and can access information that identifies transactions that the user “John Doe” has performed, predicted locations where the user “John Doe” has been, is, or will be located, and/or other information pertinent to authenticating the transaction performed by the user identified as “John Doe.”

In some instances, the authentication engine 240 can determine to access information at the social network engine 220 based on the received information and the information accessed at the data store 242. For example, the authentication engine 240 may receive information identifying a condition associated with authenticating a transaction, such as a condition that a location associated with the transaction performed by the user 202 must match a predicted current location of the user 202. Based on accessing information at the data store 242 that identifies a predicted current location of the user 202, the authentication engine 240 may determine to bypass accessing information at the social network engine 220 either in whole or in part, e.g., by determining not to access the social network engine 220 or by determining only to access specific information at the social network engine 220, e.g., information associated with satisfying other conditions associated with authenticating the transaction.

The authentication engine 240 can determine to access information at the social network profile 220, and can transmit information to the social network engine 220 to access the information. For example, the authentication engine 240 can transmit information to the social network engine 220 that requests access to data associated with the social network profile of the user 202. In some instances, the information transmitted to the social network engine 220 to gain access to the data associated with the social network profile of the user 202 can include login information associated with the social network profile of the user 202, can include information identifying the social network profile of the user 202, and/or can include information that requests specific information associated with the social network profile of the user 202, such as location data associated with the social network profile of the user 202.

In some implementations, the user 202 can permit the authentication engine 240 and/or an entity associated with the authentication engine 240, e.g., an authentication authority, to access information associated with their social network profile. For example, information stored in association with the user account belonging to the user 202 may indicate that the user 202 has permitted social network based authentication of transactions, where permitting social network based transaction authentication includes permitting access to information associated with their social network profile. In some implementations, the authentication engine 240 can only access information associated with the social network profile of the user 202 based on transmitting information that indicates that the user 202 has granted permission to perform social network based transaction authentication to the social network engine 220. In other implementations, the social network engine 220 can store information indicating that the user 202 has permitted social network based transaction authentication, and a request to access information associated with the social network profile of the user 202 can only be processed by the social network engine 220 based on the social network engine 220 determining that the user 202 has provided permission to perform social network based transaction authentication.

The social network engine 220 can receive the information identifying the social network profile of the user 202 from the authentication engine 240, and can identify information associated with the social network profile of the user 202 and/or location data associated with the social network profile of the user 202. The social network engine 220 can transmit information associated with the social network profile of the user 202 and/or location data associated with the social network profile of the user 202 to the authentication engine 240 during operation (E). The authentication engine 240 can receive the information from the social network engine 220, and can perform social network based authentication of the transaction performed by the user 202 based on the received information. In some implementations, the social network engine 220 can transmit the information associated with the social network profile of the user 202 and/or the location data associated with the social network profile of the user 202 over one or more networks, such as the network 150.

In some instances, the social network engine 220 can identify information associated with the social network profile of the user 202 and/or location data associated with the social network profile of the user 202 based on receiving a request for information from the authentication engine 240. For example, the social network engine 220 can receive information from the authentication engine 240 that identifies a social network profile of the user 202, and/or that includes login information associated with accessing the social network profile of the user 202, and the social network engine 220 can access the information and/or location data associated with the social network profile of the user 220 based on receiving the information.

In some implementations, accessing and transmitting the information associated with the social network profile of the user 202 can require the permission of the user 202. The social network engine 220 can access the information associated with the social network profile of the user 202 based on determining that the user 202 has permitted information and/or location data associated with their social network profile to be accessed, e.g., to be accessed for performing social network based transaction authentication.

In some implementations, the information associated with the social network profile of the user 202 accessed by the social network engine 220 can include personal information associated with the user 202. For example, the information accessed by the social network engine 220 can include information associated with the user 202, such as a current relationship status, age, physical characteristics, hometown, current location of residence, employer, interests, one or more endorsements that the user 202 has registered with the social networking platform, other users that are included in the social network of the user 202, one or more images of the user 202, and other information.

In some implementations, the social network engine 220 accesses location data associated with the social network profile of the user 202. Such location data may include, for example, information identifying a user-provided current location of residence, place of employment, one or more places of education, a hometown, locations of residence of members of the user's 202 social network, locations of business or other entities that the user 202 has endorsed through the social networking platform, locations associated with or identified from messages, posts, comments, or other communications registered with the social networking platform and that are associated with or identify the social network profile of the user 202, images, videos, or other content items posted to the social networking platform that are associated with locations and that identify the social network profile of the user 202, “check-ins” that identify one or more locations and that identify the social network profile of the user 202, events that the user 202 is attending or hosting and that are associated with locations, or any other information received and/or registered at the social networking platform that identifies a location and the social network profile of the user 202.

In some implementations, the information and/or location data that is accessed by the social network engine 220 is data stored by the social network engine 220 or at a data store accessible to the social network engine 220 and that is used by the social networking platform to perform operations relevant to the social network. For example, the same data stored by the social network engine 220 and used to generate posts, report “check-ins,” include information in social network profiles associated with users of the social networking platform, etc., can be accessed by the social network engine 220 and transmitted to the authentication engine 240.

The information associated with the social network profile of the user 202 and/or the location data associated with the social network profile of the user 202 can include data associated with social network interactions between users of the social networking platform. The stored information can identify locations, times, and users associated with the interactions that have been registered with the social networking platform. For example, the social network engine 220 can receive data that is associated with interactions performed by the user 202 with other users of the social networking platform that have been registered with the social networking platform, and the social network engine 220 can analyze the data associated with the interactions to identify locations, times, and users associated with the registered data.

For example, the social network engine 220 can receive data associated with posts, for example, messages posted to a “news feed” 222, information from a social network profile associated with a user of the social networking platform, information associated with “check-ins” that a user has registered with the social networking platform, etc., and the social network engine 220 can analyze the received data. For example, the social network engine 220 can analyze comments and messages posted to the social networking platform by the user “John Doe,” e.g., the post “Made it to The Colosseum,” to determine locations where the user “John Doe” has been located and times when the user “John Doe” has been located at those locations, e.g., to determine a time when the user “John Doe” was located at “The Colosseum” in Rome, Italy. In another example, the social network engine 220 can analyze “check-in” data that the user “John Doe” has registered with the social networking platform, e.g., data indicating that the user “John Doe” “checked-in” to “Fiumicino Airport” in Rome, Italy, and can determine a time when the user “John Doe” was located at the “Fiumicino Airport” in Rome, Italy.

In some implementations, the social network engine 220 can identify and transmit the information associated with the social network profile of the user 202 and/or the location data associated with the social network profile of the user 202 to the authentication engine 240 based on one or more conditions associated with transmitting the information being satisfied. For example, the social network engine 220 can determine that the user 202 has permitted the authentication engine 240 to access the information and/or location data associated with the social network profile of the user 202, and can transmit the information and/or location data to the authentication engine 240 based on determining that the user 202 has provided the permission.

Other conditions can be analyzed in determining whether the social network engine 220 can access and transmit the information and/or location data associated with the social network profile of the user 202. For example, based on receiving information associated with a request to access information associated with a social network profile of the user 202 and/or location data associated with the social network profile of the user 202, the social network engine 220 can cause a notification or request for feedback to be provided at a client device associated with the user 202. The notification or request for feedback can request that the user 202 confirm that the information associated with their social network profile and/or the location data associated with their social network profile can be accessed to perform social network based transaction authentication. Based on receiving input form the user 202 indicating that the information and/or location data associated with their social network profile can be accessed to perform social network based transaction authentication, the social network engine 220 can transmit the information associated with the social network profile of the user 202 and/or the location data associated with the social network profile of the user 202 to the authentication engine 240.

In some instances, authorization to access the information and/or location data must be received each time that social network based transaction authentication is performed or requested to be performed. For example, each time that the authentication engine 240 transmits information to the social network engine 220 to access information associated with the social network profile of the user 202 and/or location data associated with the social network profile of the user 202, a request for permission to access the information and/or location data associated with the social network profile of the user 202 can be provided for output to the user 202. In such an example, the information and/or location data associated with the social network profile of the user 202 may only be transmitted to the authentication engine 240 based on the user 202 providing input indicating that they authorize the information and/or location data to be accessed. In other implementations, the user 202 must only provide permission for the social network engine 220 to access information and/or location data associated with their social network profile a single time, the permission may be valid for a predetermined period of time, or the permission may be valid until the user 202 revokes the permission.

The authentication engine 240 can receive the information associated with the social network profile of the user 202 and/or the location data associated with the social network profile of the user 202, and, during operation (F), can provide a response to the merchant system 110 that indicates whether the transaction performed by the user 202 has been authenticated. For example, the authentication engine 240 can receive the information associated with the social network profile of the user 202 and/or the location data associated with the social network profile of the user 202 from the social network engine 220, and can perform social network based transaction authentication based on the received information and/or location data. The authentication engine 240 can transmit information indicating whether the transaction has been authenticated to the merchant system 110 over or more networks, such as the network 150.

In some implementations, performing social network based transaction authentication involves predicting a current location of the user 202. The authentication engine 240 can determine the predicted current location of the user 202 based on the information received from the social network engine 220. For instance, the authentication engine 240 can analyze the information associated with the social networking profile of the user 202 and/or the location data associated with the social networking profile of the user 202 to determine the predicted current location of the user 202.

In some implementations, the authentication engine 240 can determine that the predicted current location of the user 202 is the location most recently identified by the information received from the social network engine 220. For example, the location data associated with the social network profile of the user 202 can identify a number of locations that the user 202 has been located, as well as times when the user 202 has visited each of the locations, and the authentication engine 240 can identify the most recently visited location as the predicted current location of the user 202.

As used in this specification, a time associated with a user visiting a particular location may be a time when the user registers the particular location with the social networking platform, e.g., a time when the user posts a message to the social networking platform that identifies the particular location, or can be a time that is different from when the user registers the particular location with the social networking platform, e.g., the user can post a message to the social networking platform indicating that they plan to attend an event in a particular location at a time in the future or visited a particular location at a time in the past. In some instances, the predicted current location of the user 202 can be the location associated with a time that is the closest to a current time or date.

In some implementations, the authentication engine 240 can determine that the predicted current location of the user 202 is the location that is most frequently identified by the information received from the social network engine 220. For example, the location data associated with the social network profile of the user 202 can identify a number of locations that the user 202 has been located, as well as times when the user 202 has visited each of the locations, and the authentication engine 240 can identify the most frequently visited location as the predicted current location of the user 202. In some instances, authentication engine 240 can determine the most frequently visited location for a particular period of time or for a threshold period of time. For example, the authentication engine 240 can determine that the predicted current location of the user 202 is the location that has been the most frequently identified location within the past 30 days, or for the current calendar month.

In some implementations, the authentication engine 240 can determine multiple predicted current locations of the user 202 based on the information received from the social network engine 220. For example, the location data associated with the social network profile of the user 202 can identify multiple locations that the user 202 has been located, as well as times when the user 202 has visited each of the locations. The authentication engine 240 can identify more than one of the multiple locations as predicted current locations of the user 202, e.g., based on determining that the user 202 may be frequently traveling between the two locations. For example, location data associated with a social network profile of a user may indicate that the user is frequently located in Washington, D.C. on the weekends and is frequently located in Boston, Mass. on weekdays. Based on the location data indicating that the user may frequently travel to Boston to work, the authentication engine 240 may identify both Washington, D.C. and Boston, Mass. as predicted current locations of the user. In some instances, the multiple predicted current locations of the user 202 may be the most recently visited or most frequently visited locations by the user 202. In some instances, the multiple predicted current locations of the user 202 may be locations visited by the user 202 for a particular period of time or for a threshold period of time, e.g., locations visited by the user 202 within the past 30 days or within the current calendar month.

In some implementations, the authentication engine 240 can determine the predicted current location of the user 202 based on assigning scores to one or more locations identified by the information received from the social network engine 220 and selecting a particular location as the current location of the user 202 based on the assigned scores. For example, the location data associated with the social network profile of the user 202 can identify two or more locations that the user 202 has been located, and can further indicate other information associated with the user visiting the locations and/or the user registering the locations with the social networking platform. For example, the location data can identify times when the user 202 visited each of the locations, can identify a method used by the user 202 to register each of the locations with the social networking platform, e.g., by performing a “check-in,” by mentioning the location in a post, etc., can identify a device used by the user 202 to register each of the locations with the social networking platform, e.g., a mobile device, a desktop computer, etc., can indicate information associated with the location, e.g., whether the location is an airport, restaurant, museum, etc. Scores can be assigned to each of the locations where the user 202 has visited based on the information, e.g., such that a particular score associated with a location reflects a level of confidence that the user 202 is currently located at the location. In some implementations, different pieces of information may have different weights in determining a score to assign a particular location, e.g., such that the method used by the user 202 to register the particular location has a greater weight in determining the score than the device used to register the particular location with the social networking platform.

The authentication engine 240 can determine the predicted current location of the user 202 based on the scores of the two or more locations, e.g., by selecting the location associated with the highest score as the predicted current location of the user 202. In practice, other methods can be used to select a particular location as the predicted location of the user 202, e.g., by selecting the location assigned the lowest score, or based on another method.

In some implementations, the authentication engine 240 can determine to remove one or more locations from the set of locations where the user 202 may perform transactions. For example, information received at the authentication engine 240 from the user account engine 230 can identify one or more locations where the user 202 may perform transactions. Based on analyzing information received from the social network engine 220, the authorization engine 240 can determine to exclude one or more of these locations from the set of locations where the user 202 may perform transactions.

For example, information associated with a user account belonging to the user 202 may indicate that the user 202 is permitted to perform transactions within a particular region of the United States. Based on determining that the user is not likely located in the particular region of the United States, however, the authentication engine 240 can determine to remove the particular region of the United States from the set of locations where the user 202 may perform transactions. For example, the authentication engine 240 may analyze location data received from the social network engine 220 and may determine that a predicted current location of the user 202 is Rome, Italy. Based on determining that the user 202 is likely located in Rome, Italy, the authentication engine 240 may determine that the user 202 cannot perform transactions from the particular region of the United States.

In some instances, removing a particular location from the set of locations where the user 202 may perform transactions may involve temporarily removing the particular location from the set of locations, permanently removing the particular location from the set of locations, removing the particular location from the set of locations unless the user 202 provides information indicating that they are currently located at the particular location, or may involve removing the particular location from the set of locations subject to other conditions.

In some implementations, determining a predicted current location of the user 202 includes determining a range around the predicted current location of the user 202 where the user 202 may perform transactions. For example, the authentication engine 240 may determine that the user 202 may perform transactions in a particular location, e.g., in Rome, Italy, and may further determine that the user 202 may perform transactions within a predefined range of the particular location, e.g., within a 50 mile radius of Rome, Italy. In other implementations, other implementations, other methods may be used to determine locations where the user 202 may perform locations. For example, the user 202 may be permitted to perform transactions at any location that has a mailing address that identifies Rome, Italy, may be permitted to perform transactions at any location within a region corresponding to an area code for the predicted current location of the user 202, or can be permitted to perform transactions at locations near the predicted current location of the user 202 that are determined based on other information or criteria.

In some implementations, a location that is determined to be a predicted current location of the user 202 can included in a set of locations where the user 202 may perform transactions, and the location can remain a part of the set of locations where the user 202 may perform transactions for a period of time. In some instances, for example, a particular location can remain a location where the user 202 may perform transactions for a particular period of time, e.g., for up to one week or one month. In other instances, the particular location can remain a location where the user 202 may perform transactions indefinitely, or until the authentication engine 240 determines that the user 202 is located in a new location. In some instances, the period of time that user 202 may perform transactions from a particular location may be a period of time that is calculated based on times when the user 202 has identified the particular location at the social networking platform, e.g., such that the user 202 may perform transactions within seven days of the user 202 posting information at the social networking platform that identifies the predicted current location, or the period of time may be calculated based on other factors, e.g., based on when the user 202 first performs a transaction from the particular location or based on the time of an event that the user 202 is attending at the particular location.

The authentication engine 240 can evaluate one or more conditions associated with authenticating transactions performed by the user 202 based on the information received from the social network engine 220 and the analysis of the information received from the social network engine 220. For example, authenticating a transaction performed by the user 202 may require that a location-based condition in addition to one or more other conditions be satisfied, and the authentication engine 240 can evaluate the location-based condition and other conditions using at least the information received from the social network engine 220.

For example, a location-based condition may require that a predicted current location of the user 202 correspond to a particular predetermined region. A particular predetermined region may, in some implementations, be a region where the user 202 is known to live, to frequently visit, or may be region that has been predetermined based on other reasons. For instance, a user 202 may live in a particular region of the United States, and evaluating the location-based condition may include determining whether the predicted current location of the user 202 corresponds to the region of the United States where the user 202 lives.

In other examples, a location-based condition may require that a predicted current location of the user 202 correspond to a location associated with the transaction performed by the user 202. As described, the authentication engine 240 may receive information from the merchant system 110 identifying a location associated with the transaction performed by the user 202, and may additionally determine a predicted current location of the user 202 based on receiving information from the social network engine 220. The authentication engine 240 can determine whether the predicted current location of the user 202 corresponds to the location associated with the transaction, can determine whether the predicted current location of the user 202 is within a threshold distance of the location associated with the transaction, or can otherwise determine whether the predicted current location of the user 202 satisfies a location-based condition relating to the location of the transaction.

The authentication engine 240 can evaluate other conditions associated with authenticating a transaction performed by the user 202. In some implementations, the authentication engine 240 can evaluate the other conditions in addition to or in lieu of evaluating one or more location-based conditions. For example, evaluating one or more other conditions may involve evaluating a signature of the user 202, a time or date associated with the transaction, a PIN or other identification code information provided by the user 202 and related to performing the transaction, biometric data provided by the user 202 and related to performing the transaction, or can include evaluating other conditions associated with authenticating the transaction performed by the user 202.

Based on evaluating the one or more conditions, the authentication engine 240 transmits information that indicates whether the transaction has been authenticated during operation (F). The authentication engine 240 can transmit the information to the merchant system 110 over one or more networks, such as the network 150.

The information transmitted by the authentication engine 240 to the merchant system 110 can include information indicating whether the transaction performed by the user 202 has been authenticated. In some implementations, the information transmitted to the merchant system 110 by the authentication engine 240 can optionally include additional information relevant to the transaction, to authenticating the transaction, or to the processing of the transaction.

Information transmitted by the authentication engine 240 to the merchant system 110 and associated with the transaction can include, for example, information identifying the user 202, information identifying a user account belonging to the user 202 and used to perform the transaction, information identifying a time, date, or location associated with the transaction, or other information. Information transmitted by the authentication engine 240 to the merchant system 110 and associated with authenticating the transaction can include information that identifies the current predicted location of the user 202, information identifying the one or more conditions evaluated during the authentication process, information identifying a signature of the user 202, information identifying the methods used to authenticate the transaction performed by the user 202, and other information. Information transmitted by the authentication engine 240 to the merchant system 110 and relating to processing the transaction can include information that identifies an available balance or available line of credit associated with the user account belonging to the user 202, can identify a maximum permitted transaction amount for the user account, or can identify other information associated with the processing of the transaction performed by the user 202.

In some implementations, information associated with the transaction performed by the user 202 and/or authenticating the transaction can be provided to the user 202. For example, information provided to the user 202 can indicate whether the transaction was authenticated or was not authenticated and/or can indicate details of the transaction, e.g., a monetary value associated with the transaction, a time, date, and location associated with the transaction, etc.

In some implementations, the information can be provided to the user 202 as a notification, e.g., by providing a push notification at a mobile device of the user 202, or by sending the user 202 an automated email, text message, multimedia message, telephone call, or other notification. In some implementations, the user 202 can be provided information through the user account belonging to the user 202, e.g., based on a message being sent to the user account that includes information associated with the transaction and/or authentication of the transaction, or can be provided information through the social network profile of the user 202, e.g., based on a message being sent to the social network profile that includes information associated with the transaction and/or authentication of the transaction.

In some implementations, the authentication engine 240 can store information received from the social network profile 220, information received from the user account engine 230, information associated with the transaction performed by the user 202, and/or information associated with the authentication of the transaction performed by the user 202. In some instances, the authentication engine 240 can store the information at the data store 242 associated with the authentication engine 240.

Based on the received information, the authentication engine 240 may identify one or more entries at the data store 242 that correspond to the user 202. For example, the authentication engine 240 may receive information identifying the user 202 and/or a user account belonging to the user 202 during operation (C), and can receive information associated with the social network profile of the user 202 and/or location data associated with the social network profile of the user 202 from the social network engine 220 during operation (E). The authentication engine 240 can identify entries stored at the data store 242 that are associated with the user 202, the user account belonging to the user 202, and/or the social network profile of the user 202. For example, the authentication engine 240 may receive information that identifies the user 202 that is identified by the name “John Doe,” and the authentication engine 240 can identify entries at the data store 242 that also identify the user 202 identified by the name “John Doe.” For example, the authentication engine 240 can identify entries at the data store 242 that identify the user 202 and predicted previous locations of the user 202, e.g., information that identifies that the user 202 was likely located at the “National Gallery of Art” in Washington, D.C. on April 1, and that the user 202 was likely located at “Oyamel Restaurant” on May 5.

Based on identifying entries stored at the data store 242 that are associated with the user 202, the user account belonging to the user 202, and/or the social network profile of the user 202, the authentication engine 240 can store information at the data store 242 in associated with the entries for the identified user 202, the user account, and/or the social network profile. For example, the authentication engine 240 can store information at the data store 242 in association with the existing entries for the user 202 that identify the that the user 202 was located at “Fiumicino Airport” in Rome, Italy on July 1 and that the user 202 was located at “The Colosseum” on July 10. In some implementations, the authentication engine 240 can store additional information at the data store 242, such as information identifying the user 202, information associated with the user account belonging to the user 202, information associated with the social network profile of the user 202, location data associated with the social network profile of the user 202, information associated with analyses performed by the authentication engine 240, or other information.

In some implementations, the authentication engine 240 can determine that the data store 242 does not include entries corresponding to the user 202, and can determine to create a new entry corresponding to the user 202. For example, the authentication engine 240 can create a new entry at the data store 242, where the entry corresponds to the user 202, the user account belonging to the user 202, or the social network profile of the user 202. The authentication engine 240 can store information in association with the new entry, for example, the information described previously.

Based on receiving the information indicating whether the transaction performed by the user 202 has been authenticated, the merchant system 110 can perform operations to authenticate the transaction and/or to process the transaction. For example, if the received information indicates that the transaction performed by the user 202 has been authenticated, the merchant system 110 can perform additional operations to process the transaction. If the received information indicates that the transaction has not been authenticated, the merchant system 110 can perform operations to notify the user 202 that the transaction has not been authenticated, or can perform additional or different operations.

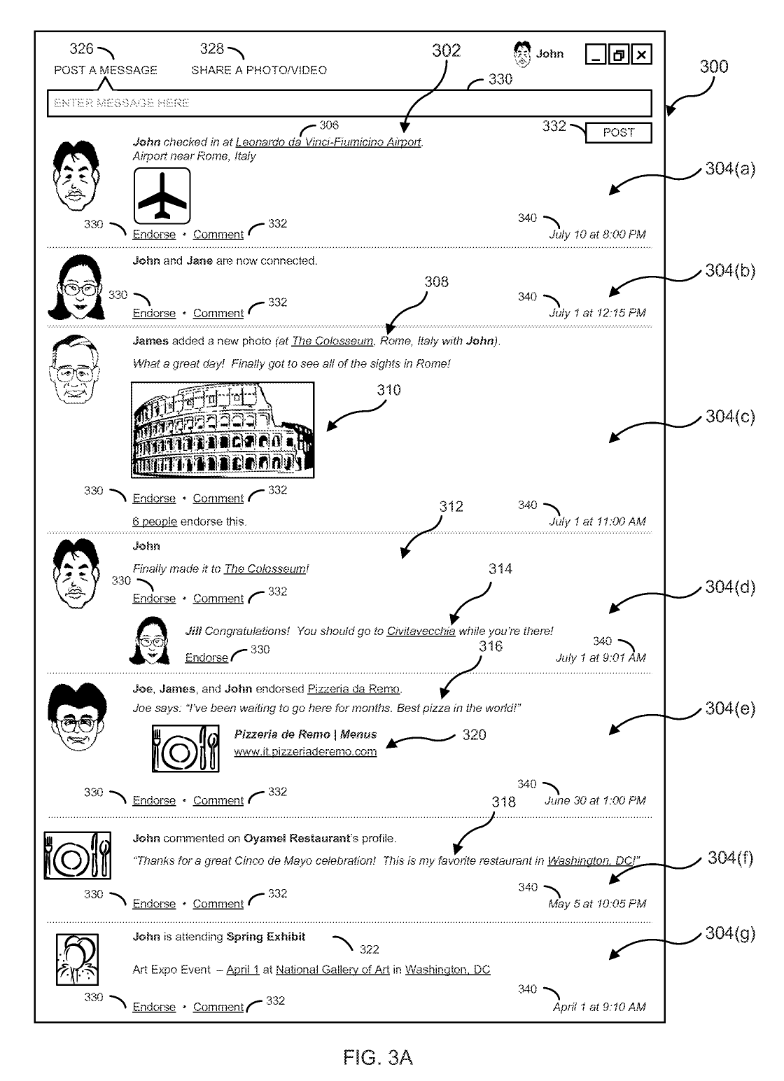

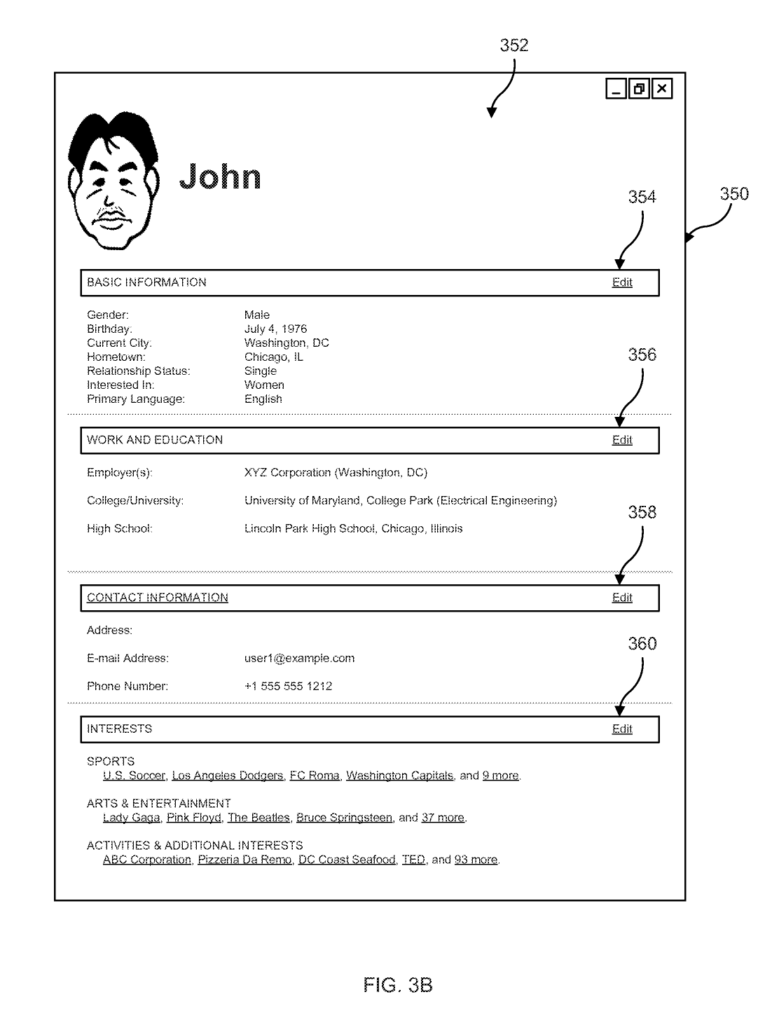

FIG. 3A illustrates an example user interface 300 of a social networking platform. The user interface 300 includes information provided by users of the social networking platform that can be analyzed to perform social network based transaction authentication. For example, the user interface 300 can represent a “news feed” 302 associated with a user named John that includes different feed items 304(a)-304(g). The items 304(a)-304(g) included in the “news feed” 302 include content and/or electronic messages that have been shared by the user John or that have been shared by other users of the social networking platform and that mention or otherwise include the user John. In some instances, the other users of the social networking platform can be users that are members of the social network of the user John.

In some implementations, the information included in the “news feed” 302 can be stored by the social networking platform at the social network engine 120. Information from the “news feed” 302 can be accessed by the authentication engine 140 to perform social network based transaction authentication.

The user interface 300 can include controls that enable the user John to interact with the social networking platform as well as with other members of his social network. For example, the user interface 3000 can include controls 326 to “Post a Message” to the social networking platform and a control 328 to “Share a Photo/Video” at the social networking platform. To enable John to perform such operations, the user interface 300 includes a text box 330 and a control 332 associated with posting a message, image, or video to the social networking platform.

Content included in the “news feed” items 304(a)-304(g) can indicate locations and times that can be used to predict a location of residence for a user. For example, the “news feed” 302 includes a “check-in” post 304(a) that indicates that John has visited “Leonardo da Vinci-Fiumicino Airport” in Rome, Italy. John or members of John's social network can view the “check-in” post 304(a) and can select a link 306 to view information about the airport, such as the airport's location, website, hours of operation, featured airlines, reviews of the airport, driving directions to the airport, etc.

The “news feed” 302 also includes the item 304(b) indicating that John is now connected with another user of the social networking platform named Jane. In some implementations, John or other members of John's social network can select the user name “Jane” to view a social network profile that includes more information about her, such as her location of residence, employment information, or other information. For example, John can select the name “Jane” in the “news feed” 302, or can select the image of Jane that accompanies the “news feed” item 304(b) to view additional information about Jane.

The “news feed” item 304(c) includes an image 310 that has been uploaded by a user James that is a member of John's social network. The image 310 is accompanied by a message 308 indicating that James uploaded the image 310 from “The Colosseum” located in Rome, Italy, and that James is at “The Colosseum” with John. The message 308 further includes a caption associated with the image 310, where the caption states, “What a great day! Finally got to see all of the sights in Rome!”

The “news feed” item 304(d) includes a post 312 that John has posted to the social networking platform. The post recites, “Finally made it to The Colosseum!” where a user of the social networking platform may select a link associated with the terms “The Colosseum” to view additional information about that location. The item 304(d) also includes a comment 314 that the user Jill has posted in reply to John's post. The comment 314 reads, “Congratulations! You should go to Civitavecchia while you're there!” where a user of the social networking platform may select a link associated with the term “Civitavecchia” to view additional information about that location.

The item 304(e) included in the “news feed” 302 indicates that the users of the social networking platform named Joe, James, and John have endorsed the restaurant “Pizzeria da Remo.” In some instances, the users Joe, James, and John can endorse the restaurant “Pizzeria da Remo” by visiting a page associated with the social networking platform that corresponds to the restaurant “Pizzeria da Remo,” or can endorse the restaurant “Pizzeria da Remo” using another method. In some implementations, the social networking platform can determine that the restaurant “Pizzeria da Remo” is a business associated with a specific location, and can determine that the users Joe, James, and John have been located at the specific associated with the restaurant “Pizzeria da Remo.” The item 304(e) also includes a message 316 submitted by the user Joe that recites, “I've been waiting to go here for months. Best pizza in the world!” The item 304(e) can also include a link 320 to a website associated with the restaurant “Pizzeria da Remo.” In some instances, the link 320 can be posted by one of the users Joe, James, or John, or can otherwise be posted in associated with the item 304(e), for example, based on the social networking platform determining that the item 304(e) refers to the restaurant “Pizzeria da Remo,” the social networking platform may identify a website associated with the restaurant “Pizzeria da Remo,” and may include the website as a link 320 associated with the item 304(e).

The item 304(f) is associated with a comment 318 that the user John posted in association with a social network profile associated with “Oyamel Restaurant.” The comment 318 recites, “Thanks for a great Cinco de Mayo celebration! This is my favorite restaurant in Washington, D.C.!” The items “Oyamel Restaurant” and “Washington, D.C.” are each associated with links, where selecting the respective links can provide a user of the social networking platform additional information relating to “Oyamel Restaurant” and “Washington, D.C.” For example, selecting the link associated with “Oyamel Restaurant” can direct a user of the social networking platform to a social network profile of “Oyamel Restaurant” or can provide the user with other information about “Oyamel Restaurant,” e.g., the restaurant's operating hours, menu, etc. Selecting the link associated with “Washington, D.C.” can provide information about the location or about businesses, events, or other items associated with the location. For example, selecting the link associated with Washington, D.C. can cause an information page about the city of Washington, D.C. to be presented, e.g., showing its location, population, area sports teams, etc., can show information about popular businesses in Washington, D.C., e.g., popular restaurants or shopping areas, or can show information about upcoming events in Washington, D.C., e.g., upcoming events registered with the social networking platform that are taking place in Washington, D.C.

The “news feed” 302 includes an item 304(g) indicating that the user John is attending an event called “Spring Exhibit” on April 1 at the “National Gallery of Art” in Washington, D.C. For example, a user of the social networking platform, e.g., a host of the “Spring Exhibit,” can register the event with the social networking platform, and users of the social networking platform can indicate that they are attending the event. The event can be identified by a link 322 that is associated with a page, e.g., a webpage or a page within the social networking profile, that is associated with the event “Spring Exhibit.” In some implementations, users of the social networking platform can select the link 322 to view information about the event, including a location of the event and/or a time that the event is to occur.

The “news feed” 302 can include, for each of the items 304(a)-304(g) in the “news feed” 302, an indicator 340 that identifies a time associated with the items 304(a)-304(g). In some instances, the indicator 340 can specify a time of day, day, date, and year. The “news feed” 302 also includes an option 330 to endorse an item 304(a)-304(g), and an option 332 to provide a comment regarding an item 304(a)-304(g). In some instances, only users associated with an item or message can endorse or comment on the item or message. In other instances, any users that are members of social networks associated with the users mentioned in the item or message can endorse or comment on the item or message, or any user of the social networking platform may be able to endorse or comment on a particular item or message.

FIG. 3B illustrates an example user interface 350 of a social networking platform that includes information that can be used to perform social network based transaction authentication. As illustrated in FIG. 3B, the user interface 350 displays a profile page 352 for a social networking profile of a user of the social networking platform. As shown, the profile page 352 is a profile page associated with the social network profile of a user named John.

As illustrated in FIG. 3B, the profile page 352 for the user named John includes a basic information section 354 that records certain biographic information about John including John's gender, e.g., male, birthday, e.g., Jul. 4, 1976, current city, e.g., Washington, D.C., hometown, e.g., Chicago, Ill., relationship status, e.g., single, sexual orientation, e.g., interested in women, and primary language, e.g., English.

The profile page 352 for the user John also includes a work and education section 356 that records certain information about John's employment and education history, including John's employer and position, e.g., he is employed by XYZ Corporation, located in Washington, D.C., the college/university that John attended and his degree, e.g., University of Maryland, College Park, where he majored in electrical engineering, and the high school that John attended, e.g., Lincoln Park High School in Chicago, Ill.

The profile page 352 also includes a contact information section 358 that records certain information for John, including John's email address, e.g., user1@example.com, and phone number, e.g., +1 555-555-1212. The contact information section 358 may also include an entry field corresponding to an address associated with the user John, where John has not recorded such information with the social networking platform. Based on John not providing such information to the social networking platform, a predicted current location of John determined by the system 100 may exclude or otherwise remove from consideration the current address of the user John.

The profile page 352 for the user John also includes an interests section 360 that records certain information about John's interests, including John's sports interests, arts and/or entertainment interests, and activities and/or additional interests. For example, the interests section 360 can indicate that John is interested in “U.S. Soccer,” the “Los Angeles Dodgers,” “FC Roma,” and the “Washington Capitals,” in addition to nine other interests that are not displayed in the profile page 352 but that may be displayed by selecting a link associated with the nine other interests. The interests section 360 also indicates that John is interested in “Lady Gaga,” “Pink Floyd,” “The Beatles,” “Bruce Springsteen,” and 37 other arts and/or entertainment figures or topics, and is interested in various miscellaneous activities and interests, including “XYZ Corporation,” “Pizzeria da Remo,” “DC Coast Seafood,” “TED,” and 93 other interests. In some examples, the items included in the interests section 360 can include topics and entities that the user John has endorsed through the social networking platform. For example, the user John may have endorsed an entity, e.g., “Lady Gaga” or “XYZ Corporation” through a page associated with the entity that is registered with the social networking platform, and the entity may appear as an interest in the interests section 360 of the profile page 352 based on the user John endorsing the page associated with the entity.

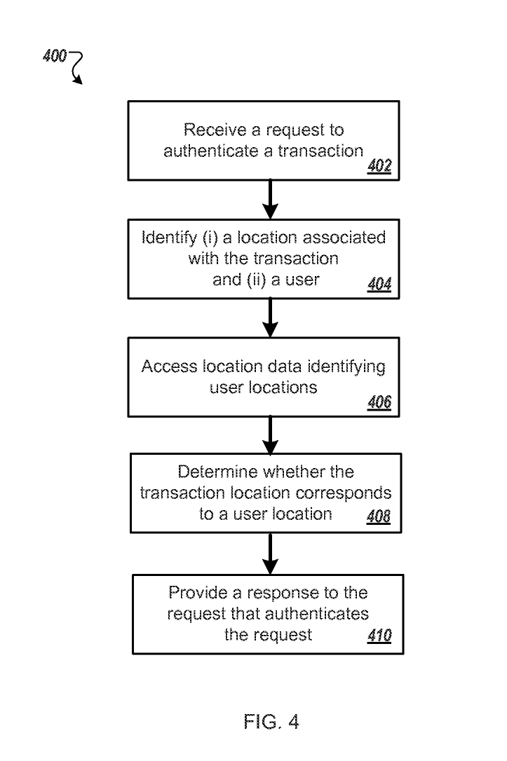

FIG. 4 illustrates an example process 400 for performing social network based transaction authentication. Specifically, the process 400 relates to determining a predicted current location of a user of a social networking platform for the purpose of performing social network based transaction authentication, in which a predicted current location of the user is compared to a location associated with the transaction.

Information is received that includes a request to authenticate a transaction performed by a user (402). For example, the authentication engine 140 can receive information requesting that the authentication engine 140 authenticate a transaction performed by the user 102. The authentication engine 140 can receive the request to authenticate the transaction from, for example, the merchant system 110. In some instances, the request to authenticate the transaction can include information associated with the transaction, such as a location associated with the transaction, a time or date associated with the transaction, a monetary value associated with the transaction, information associated with a credential provided to the merchant system 110 in association with performing the transaction, etc.

A user that performed the transaction and a location associated with the transaction performed by the user are identified based on the received information (404). For example, the authentication engine 140 can identify the user 102 and a location associated with the transaction performed by the user 102 based on the information related to the transaction that the authentication engine 140 receives from the merchant system 110. In some implementations, as described, the information received by the authentication engine 140 may identify a location associated with the transaction performed by the user 102. In other implementations, the authentication engine 140 can identify a location associated with the transaction using other methods, for example, by identifying a location associated with the merchant system 110.

Location data is accessed that identifies one or more locations associated with the user (406). For example, the authentication engine 140 can access location data associated with the user 102 who is performing the transaction by accessing location data associated with a social networking profile of the user 102 at the social network engine 220. As described, the authentication engine 140 can access the location data associated with the user 102 by identifying a social network profile of the user 102. For example, the authentication engine 140 can receive information associated with a credential, and the authentication engine 140 can identify the user 102 based on the information associated with the credential. The authentication engine 140 can identify the user 102 based on the information associated with the credential by submitting the information associated with the credential to the user account engine 130, and receiving information from the user account engine 130 that can be used to access location data associated with a social network profile of the user 102. For example, the information received from the user account engine 130 can include information identifying or used to identify a social network profile of the user 102. The authentication engine 140 can access the location data associated with the social network profile of the user 102, for example, by accessing the location data at the social network engine 220. As described, the locations associated with the user 102 may be locations where the user 102 has been located, may be predetermined locations where the user 102 may perform locations, or may be locations associated with the user 102 in another way, e.g., locations that the user 102 has identified through a social networking platform.

The location associated with the transaction and the one or more locations associated with the user are compared to determine whether the location associated with the transaction corresponds to a location associated with the user (408). For example, the authentication engine 140 can compare the location associated with the transaction to locations where the user 102 has been located that are identified by the received location data, and can determine whether the location associated with the transaction corresponds to a location where the user 102 has been located. In some implementations, determining whether the location associated with the transaction corresponds to a location of the user can involve identifying a predicted current location of the user. For example, the authentication engine 140 can receive location data associated with a social network profile of the user 102, and can determine a predicted current location of the user 102 based on the location data. The authentication engine 140 can then determine whether the location associated with the transaction corresponds to the predicted current location of the user 102.

A response to the transaction request is provided based on determining whether the location associated with the transaction corresponds to the location associated with the user (410). For example, based on the authentication engine 140 determining that the location associated with the transaction corresponds to a location associated with the user 102, the authentication engine 140 can transmit information that indicates that the transaction has been authenticated. The authentication engine 140 can transmit the response to the authentication request to the merchant system 110. In implementations in which the authentication engine 140 determines a predicted current location of the user 102, the authentication engine 140 can provide a response to the authentication request based on determining whether the location associated with the transaction corresponds to the predicted current location of the user 102. For example, based on determining that the location associated with the transaction corresponds to the predicted current location of the user 102, the authentication engine 140 can provide a response to the merchant engine 110, where the response can authenticate the transaction or can indicate that the transaction has been authenticated. In some implementations, providing a response to the authentication request that indicates that the transaction performed by the user 102 has been authenticated can enable the merchant system 110 to authenticate the transaction. Providing a response to the authentication request that authenticates the transaction can enable the merchant system 110 to process and/or complete the transaction.

Implementations and all of the functional operations described in this specification may be implemented in digital electronic circuitry, or in computer software, firmware, or hardware, including the structures disclosed in this specification and their structural equivalents, or in combinations of one or more of them. Implementations may include one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both.

The elements of a computer may include a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, examples may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Examples may be implemented in a computing system that includes a back end component, e.g., as a data server, or that includes a middleware component, e.g., an application server, or that includes a front end component, e.g., a client computer having a graphical user interface or a Web browser through which a user may interact with an implementation, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the disclosure. For example, various forms of the processes described above may be used, with steps re-ordered, added, or removed. Accordingly, other implementations are within the scope of the following claims.

What is claimed is:

1. A computer-implemented method comprising:
receiving information that includes a request to authenticate a transaction;
identifying, based on the received information, (i) a location associated with the transaction and (ii) a user associated with the transaction;
accessing location data that identifies one or more locations associated with the user;
determining, based on a comparison of the location associated with the transaction and the one or more locations associated with the user, whether the location associated with the transaction corresponds to a location associated with the user; and
providing a response to the request, based on determining whether the location associated with the transaction corresponds to the location associated with the user.

2. The method of claim 1, wherein accessing location data that identifies one or more locations associated with the user comprises accessing location data that is registered with a social network profile associated with the user.

3. The method of claim 1, wherein location data that identifies one or more locations associated with the user comprises location data that identifies one or more locations where the user has been located.

4. The method of claim 1, comprising:
determining, based on the location data that identifies one or more locations associated with the user, a likely current location of the user;
determining, based on a comparison of the location associated with the transaction and the likely current location of the user, whether the location associated with the transaction corresponds to the likely current location of the user; and
providing a response to the request, based on determining whether the location associated with the transaction corresponds to the likely current location of the user.

5. The method of claim 1, comprising:
receiving information that identifies one or more predetermined geographical location;
determining, based on a comparison of the one or more locations associated with the user and the one or more predetermined geographical locations, whether a location associated with the user corresponds to a predetermined geographical locations; and
providing a response to the request, based on determining whether a location associated with the user corresponds to a predetermined geographical location.

6. The method of claim 5, comprising:
determining, based on determining whether the location associated with the transaction corresponds to a location associated with the user, to identify the location associated with the user as a predetermined geographical location.

7. The method of claim 6, wherein determining to identify the location associated with the user as a predetermined geographical location comprises determining to identify the location associated with the user as a predetermined geographical location for a particular length of time.

8. The method of claim 1, wherein the request to authenticate the transaction is a request to authenticate a card present transaction or a card not present transaction.

9. The method of claim 1, wherein the request to authenticate the transaction is a request to authenticate a transaction associated with a transaction amount and comprising:
identifying, based on the transaction amount, one or more conditions associated with authenticating the transaction;
evaluating the one or more conditions associated with authenticating the transaction;
determining, based on the evaluation of the one or more conditions associated with authenticating the transaction, whether the one or more conditions associated with authenticating the transaction are satisfied; and
providing a response to the request, based at least on determining whether the one or more conditions associated with authenticating the transaction are satisfied.

10. The method of claim 1, wherein determining to provide a response to the request, based on determining whether the location associated with the transaction corresponds to a location associated with the user comprises:
determining that the location associated with the transaction corresponds to a location associated with the user; and
providing a response to the request that indicates that the transaction has been authenticated.

11. The method of claim 1, wherein determining to provide a response to the request, based on determining whether the location associated with the transaction corresponds to a location associated with the user comprises:
determining that the location associated with the transaction does not correspond to a location associated with the user; and
providing a response to the request that indicates that the transaction has not been authenticated.

12. The method of claim 1, wherein determining whether the location associated with the transaction corresponds to a location associated with the user comprises:
providing a request for confirmation that the transaction was performed by the user; and
receiving a response to the request for confirmation that indicates whether the transaction was performed by the user.

13. The method of claim 1, wherein accessing location data that identifies one or more locations associated with the user comprises:
accessing image data that includes one or more images that are associated with a social network profile of the user;
determining locations associated with the one or more images that are associated with the social network profile of the user; and
identifying the determined locations associated with the one or more images that are associated with the social network profile of the user as locations associated with the user.

14. The method of claim 1, wherein accessing location data that identifies one or more locations associated with the user comprises:
accessing video data that includes one or more videos that are associated with a social network profile of the user;
determining locations associated with the one or more videos that are associated with the social network profile of the user; and
identifying the determined locations associated with the one or more videos that are associated with the social network profile of the user as locations associated with the user.

15. The method of claim 1, wherein accessing location data that identifies one or more locations associated with the user comprises:
accessing text data that includes text that is associated with a social network profile of the user;
parsing the text that is associated with the social network profile of the user;
determining, based on parsing the text that is associated with the social network profile of the user, locations associated with the text that is associated with the social network profile of the user; and
identifying the determined locations associated with the text that is associated with the social network profile of the user as locations associated with the user.

16. The method of claim 1, wherein accessing location data that identifies one or more locations associated with the user comprises:
accessing endorsement data that identifies one or more endorsements associated with a social network profile of the user;
identifying, based on the endorsement data, entities associated with the endorsements that are associated with the social network profile of the user;
determining locations corresponding to the entities associated with the endorsements that are associated with the social network profile of the user; and
identifying the determined locations corresponding to the entities associated with the endorsements that are associated with the social network profile of the user as locations associated with the user.

17. The method of claim 1, wherein accessing location data that identifies one or more locations associated with the user comprises:
accessing check-in data that includes one or more check-ins that are associated with a social network profile of the user;
determining locations associated with the one or more check-ins that are associated with the social network profile of the user; and
identifying the determined locations associated with the one or more check-ins that are associated with the social network profile of the user as locations associated with the user.

18. method of claim 1, wherein accessing location data that identifies one or more locations associated with the user comprises:
accessing message data that includes one or more messages that the user has exchanged using a social network profile of the user;
determining locations associated with one or more of the messages that the user has exchanged using the social network profile of the user; and
identifying the determined locations associated with the one or more messages that the user has exchanged using the social network profile of the user as locations associated with the user.

19. A system comprising:
one or more computers and one or more storage devices storing instructions that are operable, when executed by the one or more computers, to cause the one or more computers to perform operations comprising:
receiving information that includes a request to authenticate a transaction;
identifying, based on the received information, (i) a location associated with the transaction and (ii) a user associated with the transaction;
accessing location data that identifies one or more locations associated with the user;
determining, based on a comparison of the location associated with the transaction and the one or more locations associated with the user, whether the location associated with the transaction corresponds to a location associated with the user; and
providing a response to the request, based on determining whether the location associated with the transaction corresponds to the location associated with the user.

20. A computer-readable storage device encoded with a computer program, the program comprising instructions that if executed by one or more computers cause the one or more computers to perform operations comprising:
receiving information that includes a request to authenticate a transaction;
identifying, based on the received information, (i) a location associated with the transaction and (ii) a user associated with the transaction;
accessing location data that identifies one or more locations associated with the user;
determining, based on a comparison of the location associated with the transaction and the one or more locations associated with the user, whether the location associated with the transaction corresponds to a location associated with the user; and
providing a response to the request, based on determining whether the location associated with the transaction corresponds to the location associated with the user.
